(19) United States
(12) Patent Application Publication
(10) Pub. No.: US 2010/0299199 A1
(43) Pub. Date: Nov. 25, 2010

(54) ADVERTISEMENT PROVIDING METHOD AND SYSTEM FOR MOVING PICTURE ORIENTED CONTENTS WHICH IS PLAYING

(76) Inventor: Min Soo Kang, Seoul (KR)

Correspondence Address: LEXYOUME IP GROUP, PLLC, 5180 PARKSTONE DRIVE, SUITE 175, CHANTILLY, VA, 20151, US

(21) Appl. No.: 12/518,403

(22) PCT Filed: Dec. 11, 2007
(86) PCT No.: PCT/KR2007/006427

§ 371 Date: Jun. 9, 2009

(30) Foreign Application Priority Data
Dec. 11, 2006 (KR) 10-2006-0125705

(51) Int. Cl. G06Q 30/00; G10L 15/26; G06F 17/30

(52) U.S. Cl. 705/14.49; 704/235; 707/769; 704/E15.043; 707/E17.108

(57) ABSTRACT

A method of providing advertising content customized for the content of a moving picture using text information acquired from the moving picture is disclosed. The method includes acquiring text information from a moving picture that can be played by a player; transmitting at least one piece of search target text, included in the acquired text information, to at least one search server capable of providing search results for the search target text; receiving the search results from the search server; and displaying the received search results while the moving picture is being played.

### TECHNICAL FIELD

The present invention relates, in general, to a method and system for providing advertising content customized for the content of a moving picture that is being played, and, more particularly, to a method and system for processing text information acquired from a moving picture, and providing search results, including advertising content, which are consistent with the text information, in synchronization with the moving picture that is being played.

### BACKGROUND ART

FIG. 1 is a view showing a conventional method of displaying advertising content on a Content Server (CS) moving picture player. The CS moving picture player of the present invention is software installed in an Operating System (OS) and configured to play a moving picture file, and includes Windows Media Player, supplied by Microsoft Corporation, or Gom player, supplied by Gretech Corporation as examples, at present, in 2006. The Windows Media Player is installed in an OS called Windows, and is configured to have a function of playing moving picture files having various formats. 1) A method of posting a banner or another type of advertisement on a player region other than the region where a moving picture is being played, 2) a method of displaying advertising content when a moving picture player file is opened, or 3) a method of displaying advertising content before a moving picture is played, while the moving picture is being played, or when the playback of the moving picture is ended is used as a conventional method of a CS moving picture player performing advertisement.

The CS moving picture player includes a moving picture play portion 20 configured to play a moving picture, and a CS moving picture player advertising portion operated by the party that supplies the CS moving picture player or the relevant party thereof. It can be seen that the advertisement displayed on the CS moving picture player advertising portion 21 has no relationship with the moving picture that is being played. A caption or a translated caption may be displayed on the CS moving picture player. In FIG. 1, reference numeral 22 indicates a caption that is being displayed.

FIG. 3 is a view showing a conventional method of displaying advertising content on a Web moving picture player. A Web moving picture player is a player used to select a method of playing a moving picture on a server, and transmitting a screen, on which the moving picture is being played, to the browser of a user using a streaming method. Generally, the Web moving picture player can be executed on a Web server after accessing the Web server. The Web server installs a program (the type and format thereof vary considerably, for example, a plug-in, an Active X control, and a Java applet), which can be easily installed, in the browser of a user, and enables the user to view a moving picture using a method of the program, which can be easily installed, cooperating with the Web server. The Web moving picture player is characterized in that it does not transmit a moving picture file itself to a user computer, and this fact is an important distinction between the Web moving picture player and the CS moving picture player.

1) A method of posting a banner or another type of advertisement on the margin of a Web moving picture player, 2) a method of displaying advertising content when access to a Web server is made, or 3) a method of displaying advertising content when the playback of a moving picture starts, when the playback of the moving picture is being performed, or when the playback of the moving picture ends, are used as a method of a Web moving picture player performing advertisement.

The Web moving picture player includes a moving picture playback portion 20-1 configured to play a moving picture, and a Web moving picture player advertising portion 21-1 operated by the party that supplies the Web moving picture player or the relevant party thereof. It can be seen that the advertisement displayed on the Web moving picture player advertising portion 21-1 has no relationship with the moving picture that is being played. A narration, a caption, or a translated caption, which has a relationship with a moving picture, may be displayed on the Web moving picture player. In FIG. 3, reference numeral 22-1 indicates a caption that is being displayed.

Almost no conventional advertising method, related to the CS moving picture player and the Web moving picture player, has any relationship with the content of a moving picture. Even in the case where the conventional advertising method has a minimal relationship therewith, the conventional advertising method has no relationship with the content of the specific portion of a moving picture that is currently being played, so that there is a problem in that the advertising effect is small due to the weak relationship between content and advertising. In particular, in order to play a moving picture for a plurality of users on the Web, considerable computer resources, such as a large-capacity server and a high-speed network, are necessary, and which place a load on the business that operates a Web server. Meanwhile, search keyword advertisement is an important revenue model, such as ‘Google’ (google.com) throughout the world and ‘Naver’ (naver.com) in Korea, and considered to have a higher advertisement effect than any other advertisement model on the Web. In particular, a search keyword advertisement program, such as ‘overture.com’ incorporated in ‘Yahoo’ or ‘Adsense’ of ‘Google’, adopts a method of indirectly or directly displaying the advertising content of an advertiser, which is related with a search keyword input by a user, and charging an advertiser whenever users clicks on the displayed advertising content. Such a search keyword advertisement market has grown rapidly, and has become an important revenue model for Internet businesses.

The reason for the effectiveness of the search keyword advertisement is assumed to be because the intention of a user is connected to advertisement. That is, it is interpreted that advertisement has information, and the advertisement is highly consistent with the current interest of a user (the interest appears using an entered keyword).

Therefore, a method and system for displaying the content of search keyword advertisement, which has a relationship with the specific section of a moving picture that is being played, and more particularly, that is currently being played, to users, instead of displaying banner advertisements that have no relationship with the content of the moving picture when the moving picture is played, thereby raising the advertising effect, has been keenly required to be developed. Such a method and system is further required for a User Created Content (UCC) moving picture (which is a moving picture created by a general user), which requires excessively high storage and capacity from a server and a network.

### DISCLOSURE

### Technical Problem

The present invention provides a method and system for processing text information acquired from a moving picture, and providing search results, including advertising content corresponding to the text information. The detailed technical objects of the present invention are as follows:

The first technical object of the present invention is to provide a method and system for combining with a moving picture player, which is executed by being installed in a user computer, extracting text information included in a moving picture when the moving picture player plays the moving picture, and then providing search results, including advertising content corresponding to the text information, in synchronization with the moving picture that is being played.

The second technical object of the present invention is to provide a method and system for allowing the browser of a user to access a server for playing a moving picture, extracting text information included in the moving picture when information about the moving picture that is being played on the server is acquired, and then providing search results, including advertising content corresponding to the text information, in synchronization with the moving picture that is being played.

A third technical object of the present invention is to provide a mediation server and an advertisement search server which contribute to acquire text information, included in a moving picture, and to provide search results including advertising content, and a method of operating the mediation server and the search server.

A fourth technical object of the present invention is to provide a method and system for combining with a moving picture player, which is executed by being installed in a user computer, extracting text information included in a moving picture when the moving picture player plays the moving picture, and then providing at least one keyword corresponding to the text information in synchronization with the moving picture that is being played.

A fifth technical object of the present invention is to provide a method and system for allowing the browser of a user to access a server for playing a moving picture, extracting text information included in the moving picture when information about the moving picture that is being played on the server is acquired, and then providing at least one keyword corresponding to the text information in synchronization with the moving picture that is being played.

A sixth technical object of the present invention is to provide a mediation server and an advertisement search server which contribute to acquire text information, included in a moving picture, and to provide at least one keyword, and a method of operating the mediation server and the search server.

A seventh technical object of the present invention is to provide a method and system for acquiring a moving picture file, and inserting at least one keyword, which can improve the convenience of a search for a user, into the moving picture.

An eighth technical object of the present invention is to provide the interface of a program installed in a user computer, which can simultaneously provide information about the playback of a moving picture and search results including advertising content.

An eighth technical object of the present invention is to provide the interface of a program executed in a server for playing a moving picture, which can simultaneously provide information about the playback of the moving picture and search results including advertising content.

### Technical Solution

In order to accomplish the above objects, the present invention provide a method of providing advertising content customized for the content of a moving picture using text information acquired from the moving picture, the method including acquiring text information from a moving picture that can be played by a player; transmitting at least one piece of search target text, included in the acquired text information, to at least one search server capable of providing search results for the search target text; receiving the search results from the search server; and displaying the received search results while the moving picture is being played.

The moving picture further includes tag information, and the acquiring the text information includes extracting the text information from information included in tags related to the moving picture.

The moving picture further includes UCC (User Created Content) text for the moving picture, and the acquiring the text information includes extracting the text information from UCC text for the moving picture, which is included in the moving picture.

The moving picture further includes caption information, and the acquiring the text information includes extracting the text information from the caption information.

The moving picture is a movie, and the movie further includes translated caption information, and the acquiring the text information includes extracting the text information from the translated caption information.

The moving picture further includes voice information, and the acquiring the text information includes extracting the text information from voice recognition results in text form acquired from the voice information using a voice recognition program.

The processing the acquired text information includes extracting at least one noun from the acquired text information.

The noun is at least one of the name of a product, the name of a service, and a proper noun.

The acquiring the text information is performed in synchronization with the playback of the moving picture at predetermined time intervals while the moving picture is being played.

The moving picture is played using a streaming method or is played by being downloaded to a user computer.

The acquiring the text information includes acquiring the text information for an entire moving picture at one time while storing time information in synchronization with the text information, which is being acquired, at predetermined time intervals.

The method further includes processing the acquired text information, wherein the processing the acquired text information includes performing morpheme analysis on the acquired text information, and extracting at least one of a noun and a verb as the result of the morpheme analysis.

The search server generates search results including at least one piece of advertising content corresponding to a keyword using entire search target text, received by the search server, or text, including at least one word selected from the search target text, as the keyword.

The advertising content includes the keyword.

The search server generates the search results by including at least one of the ratio of clicks to displays for the advertising content, an advertising cost per display or click for the advertising content, and information about a cost that the operator of the search server can pay for a display or a click when the advertising content is displayed or clicked.

The transmitting the search target text to the search server is performed at predetermined time intervals.

The search server generates at least one piece of advertising content of an advertiser, which corresponds to search target text, as the search results using a piece of search target text, received by the search server, as a keyword.

The method further includes performing filtering before displaying the search results received from the search server.

The method further includes performing filtering before displaying the search results received from the search server; wherein the filtering is performed in consideration of at least one of the ratio of clicks to displays for each piece of advertising content received from the search server, the advertising cost per display or click for the advertising content, and the information about a cost that the operator of the search server can pay for a display or a click when the advertising content is displayed or clicked.

The method further includes, when, as the result of the filtering, a predetermined number of pieces of advertising content cannot be displayed as the search results, displaying a predetermined number of pieces of advertising content by combining previous search results and current search results.

The search server constructs a search index which enables the server to generate search results, thereby directly generating search results for the search target text.

The search server transmits the search target text to a third server including a search index which enables the search results to be generated, and transmits the search results for the search target text, received from the third server, again.

The respective steps of the claims are generated from the player or software including the player.

The player is executed by being installed in a user computer.

The player is executed in a browser by being temporarily downloaded to the user computer.

The respective steps of claims are generated from a predetermined server for providing the moving picture.

The acquiring the text information includes acquiring the text information in synchronization with the playback of the moving picture at predetermined time intervals while the moving picture is being played; and wherein the displaying the received search results while the moving picture is being played includes displaying the received search results, which are different from each other, at the predetermined time intervals.

The search server is a server for providing a search portal service; and the search server generates search results including at least one piece of non-advertising content corresponding to a keyword using text, including at least one word, selected from the search target text received by the search server, as the keyword.

In order to accomplish the above objects, the present invention provide a method of providing advertising content customized for the content of a moving picture using text information acquired from the moving picture, the method including acquiring text information from a moving picture that can be played by a player; transmitting at least one piece of search target text, included in the acquired text information, to at least one search server capable of providing search results for the search target text; receiving the search results from the search server; and transmitting information about the moving picture to a user computer using a method selected from between a method of playing the moving picture and then transmitting information about the moving picture, which is being played, to the user computer and a method of transmitting moving picture frames so that a preset number of frames, among a series of frames that construct the moving picture, are transmitted at one time so as to play the moving picture in the user computer, the information about the moving picture being transmitted to the user computer along with the received search results.

In order to accomplish the above objects, the present invention provide a method of providing advertising content customized for the content of a moving picture using text information acquired from the moving picture, the method including receiving text information, acquired by a user computer from a moving picture which can be played by a player, from the user computer; transmitting at least one piece of search target text, included in the acquired text information, to at least one search server capable of providing search results for the search target text; receiving the search results from the search server; and transmitting the received search results to the user computer.

In order to accomplish the above objects, the present invention provide a method of providing advertising content customized for the content of a moving picture using text information acquired from the moving picture, the method including receiving text information acquired from a moving picture by a moving picture service server for transmitting information about the moving picture to a user computer using a method selected from between a method of playing the moving picture and then transmitting information about the moving picture, which is being played, to the user computer and a method of transmitting moving picture frames so that a preset number of frames, among a series of frames that construct the moving picture, are transmitted at one time so as to play the moving picture in the user computer; transmitting at least one piece of search target text, included in the acquired text information, to at least one search server capable of providing search results for the search target text; receiving the search results from the search server; and transmitting the received search results to the moving picture service server.

In order to accomplish the above objects, the present invention provide a method of providing advertising content customized for the content of a moving picture using text information acquired from the moving picture, the method including receiving text information, acquired from a moving picture by software configured to have a function of playing a moving picture and to be installed or run in a user computer, from the user computer in which the software is installed; performing a search using text, including at least one word included in the acquired text information, as a keyword; and transmitting search results, generated after performing the search, to the user computer; wherein the search results include at least one piece of advertising content corresponding to the keyword.

In order to accomplish the above objects, the present invention provide a method of providing advertising content customized for the content of a moving picture using text information acquired from the moving picture, the method including receiving text information acquired from a moving picture by a moving picture service server for transmitting information about the moving picture to a user computer using a method selected from between a method of playing the moving picture and then transmitting information about the moving picture, which is being played, to the user computer and a method of transmitting moving picture frames so that a preset number of frames, among a series of frames that construct the moving picture, are transmitted at one time so as to play the moving picture in the user computer; performing a search using text, including at least one word, included in the acquired text information, as a keyword; and transmitting search results, generated after performing the search, to the user computer; wherein the search results include at least one piece of advertising content corresponding to the keyword.

In order to accomplish the above objects, the present invention provide a method of providing advertising content customized for the content of a moving picture using text information acquired from the moving picture, the method including acquiring text information from a moving picture that can be played by a player; generating at least one search target keyword by performing morpheme analysis on the acquired text information; and displaying the search target keyword while the moving picture is being displayed; wherein the search target keyword include information which allows the search target keywords to be transmitted to a preset search server.

In order to accomplish the above objects, the present invention provide a method of providing advertising content customized for the content of a moving picture using text information acquired from the moving picture, the method including acquiring text information from a moving picture that can be played by a player; generating at least one search target keyword by performing morpheme analysis on the acquired text information; and displaying the search target keyword while the moving picture is being played and information about the moving picture that is being played is transmitted to the user computer; wherein the search target keyword includes information which allows the search target keywords to be transmitted to a preset search server.

In order to accomplish the above objects, the present invention provide a method of providing advertising content customized for the content of a moving picture using text information acquired from the moving picture, the method including acquiring text information from a moving picture on a basis selected from between a basis of a preset number of frames among a series of frames constituting the moving picture and a basis of a preset playback time period for the moving picture; generating at least one search target keyword by performing morpheme analysis on the acquired text information; and inserting the search target keyword into the moving picture corresponding to the selected basis; wherein, when the moving picture is played in a user computer, the inserted search target keyword is displayed, and the search target keyword includes information which allows the search target keyword to be transmitted to a preset search server.

In order to accomplish the above objects, the present invention provide a system for providing advertising content customized for the content of a moving picture using text information acquired from the moving picture, the system including a moving picture player for playing a moving picture; a text information acquisition module for acquiring text information from the moving picture; a search target text generation module for generating at least one piece of search target text included in the text information acquired by the text information acquisition module; a module for communication with the search server for transmitting the search target text, generated by the search target text generation module, to at least one search server capable of transmitting search results for the search target text, and receiving the search results from the search server; and an advertisement display module for, before and after the moving picture, which is being played, is transmitted to a user computer or while the moving picture to the user computer, displaying the received search results including advertising content to a user in synchronization with the moving picture, which is being received.

The moving picture further includes tag information; and the text information acquisition module acquiring the text information includes extracting information included in tags related to the moving picture.

The moving picture further includes UCC text for the moving picture, and the text information acquisition module acquiring the text information includes extracting the text information from UCC text for the moving picture, which is included in the moving picture.

The moving picture further includes caption information, and the text information acquisition module acquiring the text information includes extracting the text information from the caption information.

The moving picture is a movie, and the movie further includes translated caption information, and the acquiring the text information includes extracting the text information from the translated caption information.

The moving picture further includes voice information, and the text information acquisition module acquiring the text information includes extracting the text information from voice recognition results in text form acquired from the voice information using a voice recognition program.

The search target text generation module extracts at least one noun from the acquired text information by processing the acquired text information.

The noun is at least one of the name of a product, the name of a service, and a proper noun.

The text information acquisition module acquiring the text information includes acquiring text information in synchronization with the playback of the moving picture at predetermined time intervals while the moving picture is being played.

The advertisement display module synchronizing the search results with the moving picture includes synchronizing search results, generated based on the text information acquired at predetermined time intervals, with the playback of the moving picture.

The text information acquisition module acquiring the text information includes acquiring the text information for an entire moving picture at one time while storing time information in synchronization with the text information, which is being acquired, at predetermined time intervals.

The search target text generation module processing the acquired text information includes performing morpheme analysis on the acquired text information, and extracting at least one of a noun and a verb as the result of the morpheme analysis.

The search server generates search results including at least one piece of advertising content corresponding to a keyword using entire search target text, received by the search server, or text, including at least one word selected from the search target text, as the keyword.

The advertising content includes the keyword.

The search server generates the search results by including at least one of a ratio of clicks to displays for the advertising content, an advertising cost per display or click for the advertising content, and information about a cost that the operator of the search server can pay for a display or a click when the advertising content is displayed or clicked.

The module for communication with the search server transmits the search target text to the search server at predetermined time intervals.

The search server generates at least one piece of advertising content of an advertiser, which corresponds to search target text, as the search results using a piece of search target text, received by the search server, as a keyword.

The system further includes a filtering module for performing filtering before displaying the search results received from the search server.

The system further includes a filtering module for performing filtering on the received search results based on a predetermined basis before displaying the search results received from the search server; wherein the filtering module performing filtering based on at least one of the ratio of clicks to displays for each piece of advertising content received from the search server, the advertising cost per display or click for the advertising content, and the information about a cost that the operator of the search server can pay for a display or a click when the advertising content is displayed or clicked.

When, as the result of the filtering, the advertisement display module cannot display a predetermined number of pieces of advertising content as the search results, the advertisement display module displays a predetermined number of pieces of advertising content by combining previous search results and current search results.

The search server constructs a search index which enables the server to generate search results, thereby directly generating search results for the search target text.

The search server transmits the search target text to a third server including a search index which enables the search results to be generated, and transmits the search results for the search target text, received from the third server, again.

The text information acquisition module acquiring the text information includes acquiring the text information in synchronization with the playback of the moving picture at predetermined time intervals while the moving picture is being played; and wherein the advertisement display module displaying the received search results while the advertisement display module plays moving picture includes displaying the received search results, which are different from each other, at the predetermined time intervals.

The search server is a server for providing a search portal service; and the search server generates search results including at least one piece of non-advertising content corresponding to a keyword using text, including at least one word, selected from the search target text received by the search server, as the keyword.

In order to accomplish the above objects, the present invention provide a system for providing advertising content customized for the content of a moving picture using text information acquired from the moving picture, the system including a moving picture player for playing a moving picture; a text information acquisition module for acquiring text information from the moving picture; a search target text generation module for generating at least one piece of search target text included in the acquired text information acquired by the text information acquisition module; a module for communication with the search server for transmitting the search target text, generated by the search target text generation module, to at least one search server capable of transmitting search results for the search target text, and receiving the search results from the search server; and an advertisement display module for, when the moving picture is played, displaying the received search results in synchronization with the moving picture.

In order to accomplish the above objects, the present invention provide a system for providing advertising content customized for the content of a moving picture using text information acquired from the moving picture, the system including a moving picture player for playing a moving picture; a text information acquisition module for acquiring text information from the moving picture; a search target text generation module for generating at least one piece of search target text included in the acquired text information by performing a language processing, including morpheme analysis, on the text information acquired by the text information acquisition module; and a keyword display module for, while the moving picture is being played, displaying at least one piece of search target text as a search target keyword; wherein the search target keyword includes information which allows the search target keyword to be transmitted to a preset search server.

In order to accomplish the above objects, the present invention provide a system for providing advertising content customized for the content of a moving picture using text information acquired from the moving picture, the system including a moving picture player for playing a moving picture; a text information acquisition module for acquiring text information from the moving picture; a search target text generation module for generating at least one piece of search target text included in the acquired text information by performing natural language processing, including morpheme analysis for generating at least one search target keyword by performing morpheme analysis on the acquired text information; a search target text generation module for generating at least one piece of search target text included in the acquired text information by performing language processing, including morpheme analysis, on the text information acquired by the text information acquisition module; and a keyword combination module for, before and after the moving picture is played and then transmitted to a user computer or while the moving picture is being transmitted to the user computer, combining a search target keyword with information about the moving picture that is being transmitted using at least one piece of search target text as the keyword; wherein the search target keyword includes information which allows the search target keyword to be transmitted to a preset search server.

In order to accomplish the above objects, the present invention provide a system for providing advertising content customized for the content of a moving picture using text information acquired from the moving picture, the system including a text information acquisition module for acquiring text information from a moving picture on a basis selected from between a basis of a preset number of frames among a series of frames constituting the moving picture and a basis of a preset playback time period for the moving picture; a search target text generation module for generating at least one piece of search target text included in the acquired text information by performing a language processing, including morpheme analysis, on the text information acquired by the text information acquisition module; and a search keyword combination module for inserting at least one search target keyword into the moving picture corresponding to the selected basis; wherein, when the moving picture is played on a user computer, the inserted search target keyword is displayed, and the search target keyword includes information which allows the search target keyword to be transmitted to a preset search server.

In order to accomplish the above objects, the present invention provide a system for providing advertising content customized for the content of a moving picture using text information acquired from the moving picture, the system including a moving picture display portion for displaying a moving picture, which is being played, so as for users to view the moving picture; a moving picture playback adjustment unit for adjusting one or more preset functions related to the playback of the moving picture; and a search results display portion for displaying search results, received from a search server related to at least one piece of text information included in the moving picture, in the margin of the moving picture display portion; wherein the search results display portion is displayed at least when the moving picture is being played, and the search results include search advertising content.

In order to accomplish the above objects, the present invention provide a system for providing advertising content customized for the content of a moving picture using text information acquired from the moving picture, the system including a moving picture display portion for displaying a moving picture that is being played, so as for users to view the moving picture; a moving picture playback adjustment unit for adjusting one or more predetermined functions related to the playback of the moving picture; and a keyword display portion for displaying at least one search target keyword to be transmitted to a search server related to at least one piece of text information included in the moving picture, in the margin of the moving picture display portion; wherein the search keyword display portion can be displayed at least when the moving picture is being played, and the search target keyword includes information which allows the search target keyword to be transmitted to a preset search server.

### ADVANTAGEOUS EFFECTS

According to the present invention, advantages can be acquired as follows:

First, advertising content related to a moving picture that is being played by a CS moving picture player can be displayed to users. Therefore, the party that provides the CS moving picture player can increase additional advertisement revenue.

Second, advertising content related to a moving picture that is being played by a Web moving picture player can be displayed to users. Therefore, the party that provides the Web moving picture player can increase additional advertisement revenue. In particular, a server service provider, such as ‘youtube.com’ or ‘pandora.tv’, who provides a UCC moving picture, adopts the present invention so as to perform advertising before the UCC moving picture starts, after the UCC moving picture ends, or while the UCC moving picture is being played, so that the server service provider can increase high-priced search keyword advertisement revenue, rather than low-priced advertisements. Further, a Web site, such as ‘imbc.com’, which provides moving picture news, can increase additional advertisement revenue by displaying search keyword advertisement in synchronization with the content of the moving picture news.

Third, the advertising content is closely related to the content of the moving picture that is currently being played, with the result that the advertising effect for users is large, so that attention to the display of the advertising content can be improved, and the possibility of driving action for the advertising content, such as clicking on the advertising content, increases, thereby increasing the advertising effect.

Fourth, the mediation server makes a contract with a plurality of CS players and a plurality of Web moving picture players, and can distribute high advertisement revenue using moving pictures, which are being played by the respective CS players and the plurality of Web moving picture players, that is, using advertisements customized for the content of the moving pictures.

Fifth, the operator of the advertisement search server can increase advertising sales by developing new advertisement display sources.

### DESCRIPTION OF DRAWINGS

FIG. 1 is a view showing an example of a conventional method of displaying advertising content on a CS moving picture player;

FIG. 2 is a view showing a method of displaying advertising content on a CS moving picture player according to the present invention;

FIG. 3 is a view showing a conventional method of displaying advertising content on a Web player;

FIG. 4 is a view showing a method of displaying advertising content on a Web player according to the present invention;

FIG. 5 is a diagram showing a system for providing advertising content customized for the content of a moving picture by utilizing text information acquired from the moving picture played by a CS moving picture player according to the present invention;

FIG. 6 is a diagram showing the configuration of a text information acquisition module according to the present invention;

FIG. 7 is a diagram showing the configuration of a search target text generation module according to the present invention;

FIG. 8 is a diagram showing the configuration of an advertisement display module according to the present invention;

FIG. 9 is a diagram showing another system for providing advertising content customized for the content of a moving picture by utilizing text information acquired from the moving picture played by a CS moving picture player according to the present invention;

FIG. 10 is a diagram showing another system for providing advertising content customized for the content of a moving picture by utilizing text information acquired from the moving picture played by a CS moving picture player according to the present invention, to which an integrated search server is adopted;

FIG. 11 is a diagram showing another system for providing advertising content customized for the content of a moving picture by utilizing text information acquired from the moving picture played by a CS moving picture player according to the present invention, to which a mediation server is adopted;

FIG. 12 is a diagram showing another system for providing advertising content customized for the content of a moving picture by utilizing text information acquired from the moving picture played by a CS moving picture player according to the present invention, to which an integrated search server and a mediation server are adopted;

FIG. 13 is a diagram showing a system for providing advertising content customized for the content of a moving picture by utilizing text information acquired from the moving picture played by a Web moving picture player according to the present invention;

FIG. 14 is a diagram showing another system for providing advertising content customized for the content of a moving picture by utilizing text information acquired from the moving picture played by a Web moving picture player according to the present invention;

FIG. 15 is a diagram showing a system for providing advertising content customized for the content of a moving picture by utilizing text information acquired from the moving picture played by a Web moving picture player according to the present invention, to which a mediation server is adopted;

FIG. 16 is a diagram showing a system for providing advertising content customized for the content of a moving picture by utilizing text information acquired from the moving picture played by a Web moving picture player according to the present invention, to which an integrated search server is adopted;

FIG. 17 is a diagram showing a system for providing advertising content customized for the content of a moving picture by utilizing text information acquired from the moving picture played by a Web moving picture player according to the present invention to which an integrated search server and a mediation server are adopted;

FIG. 18 is a diagram showing a system for providing advertising content customized for the content of a moving picture by utilizing text information acquired from the moving picture played by a CS moving picture player according to the present invention;

FIG. 19 is a flowchart showing a method of operating a search target text generation module according to the present invention;

FIG. 20 is a flowchart showing a method of operating an advertisement display module according to the present invention;

FIG. 21 is a flowchart showing a method of a mediation server providing advertising content customized for the content of a moving picture by utilizing text information acquired from the moving picture played by a CS moving picture player according to the present invention;

FIG. 22 is a flowchart showing a method of an advertisement search server providing advertising content customized for the content of a moving picture by utilizing text information acquired from the moving picture played by a CS moving picture player according to the present invention;

FIG. 23 is a flowchart showing a method of an advertisement search server, which receives search target text from a mediation server, providing advertising content customized for the content of a moving picture by utilizing text information acquired from the moving picture played by a CS moving picture player according to the present invention;

FIG. 24 is a flowchart showing a method of providing advertising content customized for the content of a moving picture by utilizing text information acquired from the moving picture using a Web moving picture player according to the present invention;

FIG. 25 is a flowchart showing a method of a moving picture streaming server, which provides a moving picture using a Web moving picture player, providing advertising content customized for the content of a moving picture by utilizing text information acquired from the moving picture using a Web moving picture player according to the present invention;

FIG. 26 is a flowchart showing a method of an advertisement search server providing advertising content customized for the content of a moving picture by utilizing text information acquired from the moving picture using a Web moving picture player according to the present invention; and

FIG. 27 is a flowchart showing a method of an advertisement search server, which receives search target text from a mediation server, providing advertising content customized for the content of a moving picture by utilizing text information acquired from the moving picture played by a Web moving picture player according to the present invention;

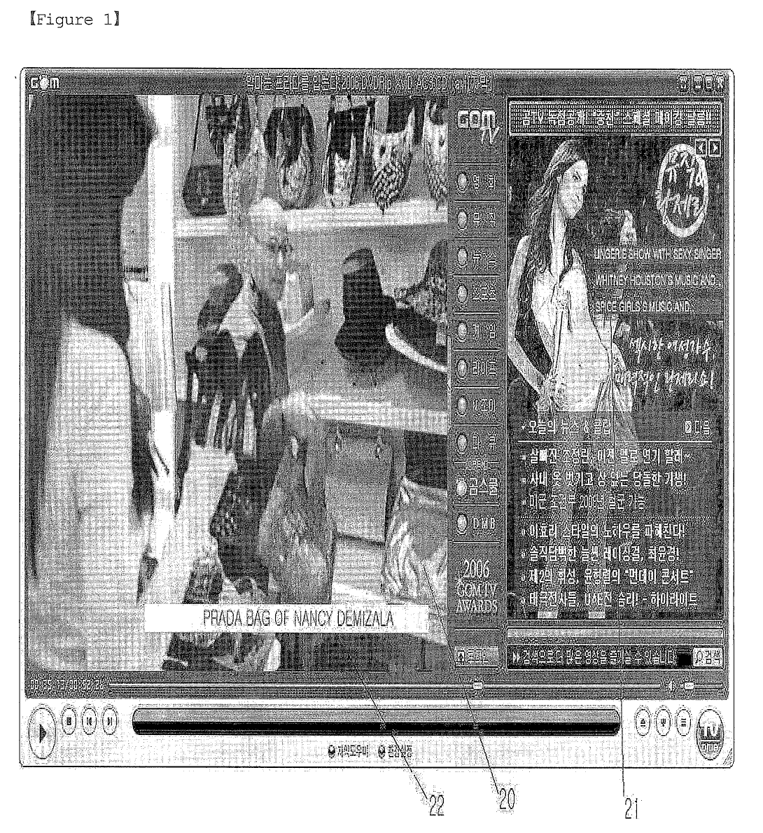

### DESCRIPTION OF REFERENCE NUMERALS OF PRINCIPAL ELEMENTS IN THE DRAWINGS

100: CS moving picture player
100-1: Web moving picture player
200: text information acquisition module
210: caption information acquisition unit
220: translated caption information acquisition unit
230: UCC tag-including information acquisition unit
240: voice reorganization information acquisition unit
300: search target text generation module
310: search target text preprocessor engine
320: search target text extraction engine
330: search target text Database (DB)
400: advertisement display module
500: advertisement search server
510: keyword acquisition unit
520: keyword processing unit 600: mediation server

### BEST MODE

Hereinafter, a detailed description will be performed with reference to the attached drawings.

The present invention includes a method and system for acquiring text information, included in a moving picture, transmitting at least one piece of search target text, included in the acquired text information, to at least one advertisement search server 500 capable of providing search results, including advertising content, for the search target text, receiving the search results, including advertising content, from the advertisement search server 500, and providing the received search results, including advertising content, to users while the moving picture is being played.

The common components will be described first before the embodiments of the present invention are described.

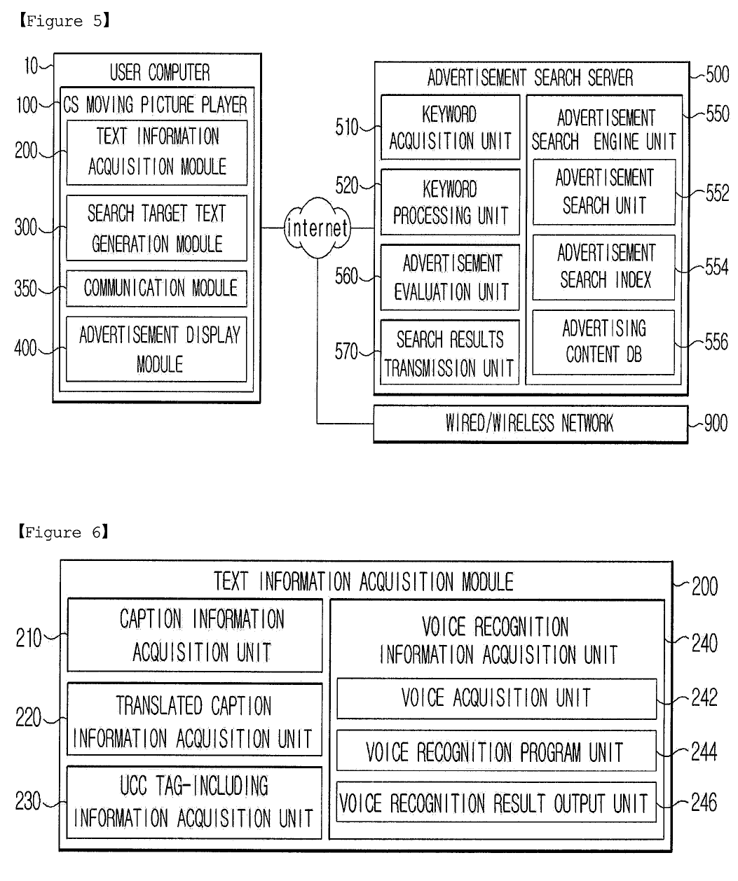

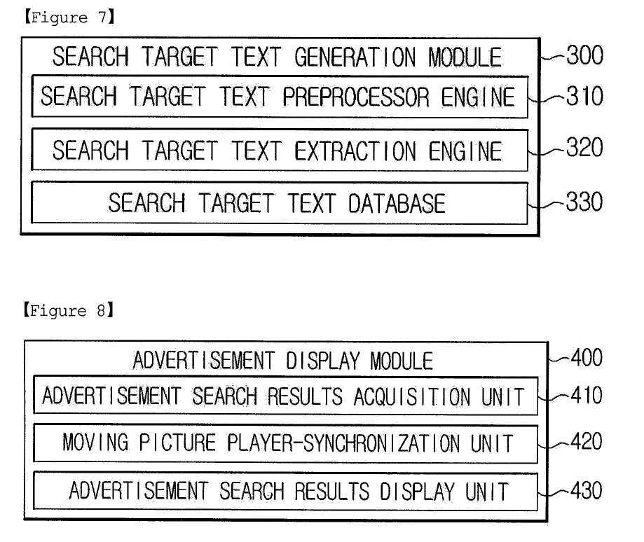

FIG. 5 shows the configuration of the present invention. Even though a description will be performed with reference to FIG. 5, it is apparent that the components that are common throughout the present invention are not limitedly used for the configuration of FIG. 5.

In order to implement the spirit of the present invention, 1) a text information acquisition module 200 for extracting text from a moving picture, 2) a search target text generation module 300 for generating search target text from text information acquired by the text information acquisition module 200, 3) an advertisement search server 500 for generating search results, including advertisement-type advertising content, for the search target text, 4) a moving picture player for playing a moving picture for users, and 5) an advertisement display module 400 for displaying the search results including the advertisement-type advertising content, are required. The configuration and operation thereof will be described in detail.

The text information acquisition module 200 extracts text from a moving picture. The moving picture treated in the present invention may be largely classified as 1) a movie moving picture, 2) an UCC moving picture, or 3) a media moving picture, such as news.

From the point of view of the present invention, the movie moving picture has four types of text extraction possibilities. The first is caption information. The caption information exists in a general moving picture file, and the caption information includes information about a caption to be displayed in a specific time zone or a specific start time point. Although the caption information may be included in the moving picture, the caption information can be provided as a separate file. Here, as an example of the latter, the format of a caption file includes a ‘smi’ file format. When this is opened using Notepad or another text editor, it can be seen that a plurality of caption information is included as follows. As an example, the caption file may have the following configuration.

<SYNC Start=3103038><P Class=KRCC>

My Starbucks is ready.

<SYNC Start=3105091><P Class=KRCC>&nbsp;

In this case, ‘SYNC Start=3103038 ’ means that the sentence “My Starbucks is ready” exists between 3103038 ms and 3105091 ms. In some countries, such as the U.S., the input of caption information corresponding to the voice information of visual media, such as movie or news, is required for the deaf. In this case, the ‘SYNC Start=3103038 ’ means that the sentence “My Starbucks is ready” comes out between 3103038 ms and 3105091 ms, and, if a caption must be displayed for the deaf, it is optimal to display the sentence at that time span. In Korea, Television (TV) news can be viewed in the form of a moving picture on a site, such as “www.mbc.co.kr”, operated by a broadcasting station, and there are many cases in which a sentence or caption information is displayed when such a news moving picture is played by a Web moving picture player 100-1.

The second is translated caption information of caption information. The translated caption information is configured to have a format which is the same as or equal to the general caption information. The following information uses an example of a translated caption from the movie “The Devil Wears Prada”. It can be seen that a plurality of caption information, such as

<SYNC Start=2113026><P Class=KRCC>

Prada bag of Nancy Demizala

<SYNC Start=2115542><P Class=KRCC>&nbsp;, is included. Here, ‘SYNC Start=2113026 ’ indicates that the caption “Prada bag of Nancy Demizala” must be displayed at a time point 2113026 ms and 2115542 ms after the movie has started.

The third is voice recognition text information used to acquire voice, included in a moving picture, using a voice recognition program. At present, in 2006, voice recognition technology has advanced considerably, and it is true that voice recognition technology has developed to the level at which almost any voice can be recognized. Further, the level of voice recognition does not need to be complete in the present invention (the objects of the present invention can be achieved even though the level of completion is considerably low), and this will be described later. For voice information included in the moving picture, the text information acquisition module 200 acquires text information from the voice information using a voice recognition module. Generally, the voice recognition module may include a voice recognition engine, or a voice pattern DB and a dictionary for voice recognition.

The fourth is UCC text information, recorded by an unspecified number of general users or managers, for a movie moving picture. That is, the UCC text information is an arbitrary type of text that users record about the movie, and generally exists together with tag information. It is preferable that the text information acquisition module 200 acquire only text information from the UCC text information other than tag names (they may be meta tags). For example, when UCC text information “Jung Dong Jin</photographing place/>” exists in a specific moving picture, it is preferable that only the text “Jung Dong Jin,” be acquired, while “photographing place,” which corresponds to a meta tag or a tag name is excluded. The text information acquisition module 200 only acquires the text information “Jung Dong Jin”.

Text information using the caption information, translated caption information, or voice recognition is characterized in that the text information can correspond to a “time” or a “time span”. If necessary, the text information may be stored corresponding to a specific frame, or a frame span, ranging from a specific frame to another specific frame. For technical convenience in the present specification, the text information will be described based on a time or a time span. However, of course, a frame or a frame span is not excluded. Meanwhile, for an entire moving picture, the UCC text information is generally recorded without consideration of a time or a time span, so that the concept of time or time span cannot correspond to the UCC text information.

The reason that the concept of a time or a time span is important is the possibility of the synchronization of the playback of a moving picture with search results, including advertising content. The reason for this is that, as long as the UCC text information has no relationship with the playback time of a moving picture, synchronization is impossible for a UCC moving picture, to which the concept of a time and a time span cannot be applied. Therefore, when the text information acquisition module 200 acquires text information, the text information acquisition module 200 can perform acquisition while writing information about a time or a time span to the acquired text information. That is, the acquired text information can be acquired or stored while corresponding to a specific time or time span.

For example, in

<SYNC Start=2113026><P Class=KRCC>

Prada bag of Nancy Demizala

<SYNC Start=2115542><P Class=KRCC>&nbsp;,

information about a time span, such as ‘SYNC Start=2113026 ’ or ‘SYNC Start=2115542 ’, can be acquired when “Prada bag of Nancy Demizala” is acquired, and information about a time span, such as ‘SYNC Start=2113026 ’ or ‘SYNC Start=2115542 ’, can be stored in conjunction with “Prada bag of Nancy Demizala” when “Prada bag of Nancy Demizala” is stored.

A UCC moving picture and a media moving picture, such as news, may include any one or more of the above-described four possibilities. In November, 2006, currently, a UCC moving picture provided from ‘www.youtube.com’ may include voice information or UCC text information, but caption information and translated caption information are not excluded in the UCC moving picture. Further, of course, a media moving picture, such as news, a drama, or a documentary, can include any one or more of the above-described four possibilities.

The method of the text information acquisition module 200 acquiring text information from a moving picture will be described in further detail below. First, since the work of acquiring text information from caption information or translated caption information is easy for those skilled in the art (since a caption file, such as an smi file, can be opened even in a notepad, that is, a text editor), the work will not be described in detail.

Further, a method of recognizing voice using a voice recognition program is a well-known technique, and various types of voice recognition solutions have been disclosed inside and outside the country, and thus the method will not be described in detail. Contrary to Text to Speech (TTX) technique for converting text into voice, the quality of current voice recognition technique is low. However, even though, in the present invention, the quality of the voice recognition technique is rather low, that is, little or no speech can be recognized, this does not raise any problem when the spirit of the present invention is implemented. The reason for this will be described later. That is, the implementation of the spirit of the present invention is sufficiently possible even at the current voice recognition technique level, based on a method which will be described later.

The UCC text information indicates various types of individual records written about the moving picture by users or managers. Although the characteristic of a save format (field name defined by a user+individual record content as field content) is comparatively free, with the spread of Web 2.0, the UCC text information is displayed together with various types of standard or non-standard tags. As the tag is suitable and complies with an actual standard or a fundamental standard, it is easy to search a large number of moving pictures for a moving picture desired by a user, and thus the method of displaying UCC text information combined with tags is steadily spreading. Since this method is considered a well-known technique area, an additional detailed description will be omitted. There are many cases in which a considerable amount of UCC text information is stored in the form of an xml file. The xml file can be viewed using a word processor, such as Notepad or Microsoft Word (of course, it can be viewed using editor software), and a method of extracting text from the UCC text information, which can be viewed, is a very easy and well-known technique. A photograph search site ‘flickr.com’ and a moving picture search site ‘youtube.com’ are famous sites that enable UCC tag information to be acquired and then used for searching.

It is preferable that the text information acquisition module 200 include any one or more of a caption information acquisition unit 210, a translated caption information acquisition unit 220, a UCC tag-including information acquisition unit 230 for acquiring information included in a tag such as UCC, and a voice reorganization information acquisition unit 240.

The voice reorganization information acquisition unit 240 may include a voice acquisition unit 242 for initially acquiring voice information from outside, a voice recognition program unit 244 for recognizing the acquired voice information, and a voice recognition result output unit 246 for outputting the recognized voice reorganization information in the form of text information.

Thereafter, the configuration and function of the search target text generation module 300 for generating search target text from the text information acquired by the text information acquisition module 200 will be described.

There may be processes for various types of selection depending on various types of preconditions, from acquiring text information from a moving picture to providing search results, including advertising content, using the acquired text information. First, a process of the search target text generation module 300 extracting at least one piece of search target text from the acquired text information will be described.

The search target text generation module 300 of the present invention includes a search target text preprocessor engine 310, a search target text extraction engine 320, and a search target text DB 330. In the case in which preprocessing is required for the acquired text information, the search target text preprocessor engine 310 performs the preprocessing at step S210. The search target text extraction engine 320 inquires acquired text information (including preprocessed text information) from the search target text DB 330 at step S220, extracts a text string which exists in the search target text DB and is consistent with the text information at step S230, and then generates search target text using the extracted test string at step S240. Therefore, the generated search target text is generated overall by the search target text generation module 300.

The search target text is text having a type which can be accepted by a server for providing search results, including advertising content, and the types thereof are largely classified into the following three types.

The first is the name of a product or service. It is preferable that the name of a product or service have a type of noun or noun phase. For example, ‘Ipod’, ‘notebook computer’, or ‘flower delivery’ is an example of a name of a product or service.

The second may be at least one “search advertisement keyword” registered by search keyword advertisers, who direct the server for providing search results, including advertising content, to perform search keyword advertisement. (A type of advertisement performed using a method of an advertiser registering a specific keyword, and enabling the advertising content of the corresponding advertiser to be displayed from among search results, including advertising content, when a searcher inputs a corresponding keyword or a keyword which is related to the keyword. The ‘AdWord’ executed on ‘google.com’ is a representative example of search advertisement keywords, as well as the search keyword advertising method performed by ‘overture.com’. Further, ‘Naver’ has released various types of search keyword advertisement products, such as ‘Pluspro’.) Search advertisement keywords are registered by advertisers, and the types thereof may be various. Examples of search advertisement keywords may be various common nouns and proper nouns, such as a brand, for example, “Prada”, the name of a product or service, the name of a place or person, and arbitrary character strings registered by advertisers.

The third is character string information, such as a phase, a paragraph, and a sentence. A plurality of search portals, such as ‘google.com’ and ‘naver.com’, or search keyword advertisement agencies, such as ‘overture.com,’ have a function of providing search results, including advertising content, which are consistent with or related to search advertisement keywords registered by respective advertisers, as well as search results including advertising content, by processing input character string information. Therefore, in order to provide search results, including advertising content, based on the acquired text information, the text information is processed by a preset unit (a sentence, a phase, or a paragraph), and then search target text is extracted.

Thereafter, based on the three models for extracting search target text, the function of a unit for extracting a search target and a model for dividing tasks between the unit and an object that interacts with the unit will be described. The search target text extraction engine 320 is actually in charge of extracting search target text.

First, a player that can play a moving picture can extract search target text, and the search target text generation module 300 is combined with or in conjunction with the player. The player is installed in an OS, like Windows Media Player or GOM Player, and may include a CS moving picture player 100, operated after being installed in a user computer 10, and a Web moving picture player 100-1, operated by a server on the Web, such as ‘youtube.com’. A method of the CS moving picture player 100 extracting search target text may include 1) a method of extracting search target text by inquiring about acquired text information from the search target text DB while including the search target text DB inside, and 2) a method of transmitting acquired text to a preset mediation server 600, processing the text information received by the mediation server 600, extracting search target text, and then the CS moving picture player 100 receiving the extracted search target text.

The search target text DB may include the names of respective products or services, or the “search advertisement keywords”. Here, the mediation server 600 can extract search target text from its own search target text DB, or using a third server having the search target text DB. Before an inquiry is performed on the search target text DB using the acquired text information, the acquired text information can be preprocessed. The preprocessing is syntax analysis or morpheme analysis (including compound noun decomposition). The search target text preprocessor engine 310 performs the preprocessing.

If acquired text is a noun or a noun phrase, an operation of inquiring about the acquired text from the search target text DB is easy (in the case of English, if a stem analyzer is used, it is simple to process a plural noun as a singular noun). However, in the case of Korean, which uses postpositional words, an operation of separating postpositional words through morpheme analysis may be required. Further, in the case of a verb, an operation of extracting a noun which has a relationship with the verb can be performed through the morpheme analysis (for example, an operation of separating “journey” from “go on a journey”). Since the operation of extracting a noun from the acquired text information using the syntax analysis or morpheme analysis is a well-known technique in a natural language processing technique, a detailed description thereof will be omitted. The preprocessing is performed by a unit which includes the search target text DB. That is, in the case in which the CS moving picture player 100 includes the search target text DB, the CS moving picture player 100 can extract search target text (the name of a product or service, a proper noun, a common noun, or search advertisement keyword) from the acquired text information, and it is the same as in the mediation server 600 or the third server. Further, the function performed by the CS moving picture player 100 can be performed by a server for operating the Web moving picture player 100-1.

Of course, although the case where the CS moving picture player 100 performs a function of extracting search target text has been described, the fact that an arbitrary program, executed in conjunction with the CS moving picture player 100, performs the corresponding function is not excluded. That is, the relationship between a module for performing a function of acquiring and/or extracting search target text and the CS moving picture player 100 includes 1) the case in which they are included in the same entire program, managed by the same service provider, 2) the case in which they are managed by the same service provider but operated as separate programs, 3) the case in which they are separate programs managed by respective service providers but cooperate with each other by performing communication therebetween (including the case in which the CS moving picture player has control rights for files played by the CS moving picture player 100, and the player provides information, acquired from the files controlled by it, to the module), and 4) the case in which they are operated by separate service providers, and the module recognizes only files played by the CS moving picture player 100 while the module acts independently of the CS moving picture player 100 (the files are included in the user computer 10), and independently performs the corresponding function. Of course, generally, only the cases 1), 2) and 3) are possible if the Web moving picture player 100-1 is used. Although the function of the module will be described as the function of the player for convenience of description in the present specification, this is an example of the present invention, and it is apparent that all of the cases 1), 2), 3), and 4), described in this paragraph, are included.

Here, the problem with the above-described voice recognition will be described in brief. The present invention has the object of extracting search target text using text information acquired from a moving picture viewed by a user, and displaying search results, including (advertisement-type) advertising content, for the extracted search target text to a user. In the case in which the voice in a moving picture is “The chief editor of a fashion journal on Fifth Avenue in New York carries a Prada bag”, it is assumed that the voice recognition function is not complete, so that “fashion” is mistakenly recognized as “fason” and “journal” is mistakenly recognized as “jonal” but “Prada” is normally recognized as “Prada” and “bag” is recognized as “bag”. In this case, if “fason” and “jonal” do not exist in the search target text DB, “fason” and the “jonal” are excluded from the search target text, and in the case in which any one or more of “Prada” and “bag” exist in the search target text DB, only the existing words are processed as search target text. That is, even though a voice recognition system is not aware of the misrecognition, only words that exist in the search target text DB, of the recognized words are processed as search target text. In this case, since it is not necessary to provide search results, including advertising content, for all of “fashion”, “journal”, “Prada”, and “bag”, a user does not feel strange even if search results including advertising content are provided only for accurately recognized words (for example, words exist in the search target text DB. Even though search target text is limitedly processed, as described above, the user recognizes only words displayed to him/her, so that there is an additional advantage in that the user perceives that the voice recognition rate is rather high, contrary to the actual voice recognition rate. That is, the reason for this is that search results, including (advertisement-type) advertising content, for “Prada” and/or “bag” are provided to the user in the above-described state. Of course, there is a case in which, although the search target text exists in the search target text DB, the advertisement search server 500 cannot provide search results including advertising content. Here, only normally acquired search results including advertising content are displayed to a user, excluding search results including advertising content that cannot be provided. (There is an extremely low possibility that such a problem will occur in the case in which only search results including non-advertisement-type advertising content are displayed. However, in the case in which search results, including advertisement-type advertising content, should be displayed, there may be a keyword, which is not registered as a search keyword advertisement by an advertiser. In this case, depending on the policy, there may be a method of displaying search results, including non-advertisement-type advertising content, or a method of displaying only search results, including advertisement-type advertising content that is normally acquired.)

The search target text DB may include the names of respective products or services, or search advertisement keywords for search keyword advertisement, registered by advertisers. A method of generating and updating the search target text DB will be described.

A set of the names of products or services can be generated using the names of respective products or services based on a product dictionary, a service name dictionary, a job name dictionary, an electronic product catalog (there is an international standard for the electronic product catalog), an electronic service catalog, or a noun dictionary (of course, the set of names of products or services can be received from an external third person), and the set of the names of products or services can be stored in a DB. Of course, the set of names of products or services can be indexed so as for a DBMS or a search engine to search it. A search advertisement keyword set, in which the search advertisement keywords are collected, can be generated by receiving the search advertisement keywords from the party that performs the search keyword advertisement (for example, a portal, such as ‘google.com’ or ‘naver.com’, which performs search keyword advertisement, or a search keyword advertisement agency such as ‘overture.com’). That is, the server of the party that performs the search keyword advertisement communicates with the CS moving picture player 100 periodically or at preset time intervals and under preset requirements, so that the search advertisement keyword set can be acquired from the server of the party that performs the search keyword advertisement, and the search target text DB can be generated and updated using the acquired search advertisement keyword set. Of course, the search advertisement keyword set may be acquired from a mediation server functioning to mediate the CS moving picture player 100 and the advertisement search server 500.

When the CS moving picture player 100 does not include the search target text DB, or when the search target text DB does not properly perform its own function even though the CS moving picture player 100 includes the search target text DB because the data included in the search target text DB is not sufficient (although a considerably large amount of text information is acquired, the search target text DB cannot generate any search target text), the third method, as described above, may be applied. In the third method, character string information, such as a phase, a paragraph, and a sentence, is transmitted to a plurality of search portals, such as ‘google.com’ and ‘naver.com,’ or a search keyword advertisement agency, such as ‘overture.com’, the search portal or the search keyword advertisement agency can generate search target text by analyzing the character string (the analysis includes arbitrary analysis, such as syntax analysis or morpheme analysis, and almost all portals accept text input in any form of a sentence, a phase, and a paragraph, and provide search results, including advertising content, based on the input text), and can transmit the search result, including advertising content corresponding to the search target text and/or the search target text, to the CS moving picture player 100. When only the search target text is received, the CS moving picture player 100 can receive search results, including advertising content, by transmitting the search target text to the advertisement search server 500. When the search results, including advertising content, are received, the CS moving picture player 100 displays the search results to a user. Of course, the mediation server 600 can perform mediation between the CS moving picture player 100 and the server of the search portal or the search keyword advertisement agency. Since works performed by the CS moving picture player 100 and the server of the search portal or the search keyword advertisement agency, information transmitted/received therebetween, and the functions thereof are apparent to those skilled in the art when the mediation server 600 is used, a detailed description thereof will be omitted.

The method of the CS moving picture player 100 transmitting the search target text to at least one of the advertisement search servers 500 capable of providing the search results, including advertising content, will be described. When text information is acquired from the moving picture, the text information is successively acquired based on the playback of the moving picture, unlike UCC tags, if the text information is acquired through 1) caption, 2) translated caption, and/or 3) voice recognition. Therefore, the CS moving picture player 100 can transmit the search target text to the advertisement search server 500 1) in a preset time unit and/or 2) in a preset search target text number (for example, new search target text is not transmitted until the preset search target text number becomes three). Meanwhile, in the case in which the text information is acquired from the UCC tag information, the playback of the moving picture based on time is independent from the acquisition of text information from the UCC tag information (they have no relationship, that is, the specific section of the moving picture has no relationship with the text information acquired from the UCC tag information), so that the search target text is extracted from the text information acquired from the UCC tags, and then the extracted search target text is transmitted to the advertisement search server 500, and the operations are independent of the playback of a specific section of the moving picture. It is preferable that the search target text acquired from the UCC tags be transmitted to the advertisement search server 500 in a section in which the number of search target text extracted using the above-described methods 1), 2), and/or 3) is smaller than a preset number (when a moving picture is played, there may be a specific section for which little voice or caption exists, so that it is difficult to extract text, and there may be a section for which little search target text is extracted for some other reason) in the start section of the moving picture, in the end section of the moving picture, and/or in the process of playing the moving picture.

Thereafter, the advertisement search server 500 for generating search results, including advertisement-type advertising content, for the search target text, will be described. The advertisement search server 500, in an embodiment thereof, may include a keyword acquisition unit 510 for acquiring a keyword transmitted from outside, a keyword processing unit 520 for processing the keyword acquired by the keyword acquisition unit 510, an advertisement search engine unit 550 for performing a search using the keyword acquired by the keyword acquisition unit 510 or the keyword processed by the keyword processing unit 520, and a search results transmission unit 570 for transmitting search results. The keyword processing unit 520 may be optionally provided, but it is preferable that the keyword processing unit 520 be present. In particular, when the search target text, generated by the search target text generation module 300, requires processing in the present invention, it is preferable that the keyword processing unit 520 be present. The reason for this is that there are generally many cases in which a search keyword advertisement, included in the advertisement search server 500, is different from a keyword input by a user, and this is similar to the search target text generated by the search target text generation module 300 of the present invention. The advertisement search engine unit 550 may further include an advertisement search unit 552 for directly performing searches, and an advertisement search index 554 and an advertising content DB 556, which are objects to be queried by the advertisement search unit 552 using a search query. Here, in the case in which a search is performed using a search engine, a method of searching the advertising content DB 556 for the presence and location of specific advertising content using the advertisement search index 554 is employed. Meanwhile, a method of directly inquiring of the advertising content DB 556 using a DB query in a Database Management System (DBMS) or another method may be employed. Here, in order to improve the question and answer speed, an index may be included in at least one specific field of the advertising content DB 556. In this case, although the advertising content DB 556 is logically inside the advertisement search server 500, the advertising content DB 556 may alternatively be outside the advertisement search engine unit 550. Further, the advertisement search server 500 may further include an advertisement evaluation unit 560 for evaluating each advertisement or advertising content. An example of the method by which the advertisement evaluation unit 560 evaluates an advertisement will be described in an advertisement evaluation method for “Prada” and “bag” below.

When the search results transmission unit 570 transmits the search target text to at least one advertisement search server 500 capable of providing the search results, including advertising content, the advertisement search server 500 searches for the received search target text, and generates search results including advertising content. Here, although the search results, including advertising content generated by the advertisement search server 500, do not exclude search results including non-advertisement type advertising content, search results including advertisement-type advertising content are more preferable. The search results including advertisement-type advertising content may be the search keyword advertising content of an advertiser, which corresponds to a search keyword registered by the advertiser. Although the search keyword advertising content of an advertiser may be formed in text, such as “AdWord” of ‘google.com’, it may be formed in a non-text type image advertisement (an advertisement which is not formed in text, such as a banner, a moving picture, or a flash file). The reason for this is that, when an advertiser cause the search keyword to correspond to the non-text type advertising content, the non-text type advertising content corresponding to the search keyword can be extracted. In the example, when “Prada” and “bag” are transmitted to the advertisement search server 500, the advertisement search server 500 can generate search results, including advertisement-type advertising content, for “Prada” and “bag”. Generally, the search results including advertisement-type advertising content may be the advertising content of the advertiser for which it is required that the advertiser pay preset costs for advertising content for “Prada” and “bag”. When a searcher enters “Prada” or “bag” as a keyword, the advertiser performs search keyword advertisement using a method of paying a price for the display of an advertiser's advertising content when the advertiser's advertising content is displayed or for the display of a specific Web site or Web page linked to the advertiser's advertising content when receiving an action of the searcher, such as clicking after advertisement content is displayed.

Here, the following four problems may arise from the point of view of the advertisement search server 500. First, there may be two or more search results, including advertisement-type advertising content, of the advertisement search server 500. In this case, the problem of whether to transmit all of the search results to the CS moving picture player 100 or to perform a method of the CS moving picture player 100 transmitting the search target text to at least one advertisement search server 500 capable of providing the search results, including advertising content, will be described. When text information is acquired from a moving picture and the text information is acquired through 1) a caption, 2) a translated caption, and/or 3) voice recognition, the text information is successively acquired over time as the moving picture is being played, unlike UCC tags. Therefore, the CS moving picture player 100 can transmit the search target text to the advertisement search server 500 1) at preset time intervals and/or 2) at preset search target text numbers (for example, new search target text is not transmitted until the preset search target text number becomes three). Meanwhile, in the case in which the text information is acquired from the UCC tag information, the playback of the moving picture over time is independent from the acquisition of text information from the UCC tag information (they have no relationship therebetween, that is, the specific span of the moving picture has no relationship with the text information acquired from the UCC tag information), so that an operation of extracting the search target text from the text information acquired from the UCC tags and then transmitting the extracted search target text to the advertisement search server 500 is performed independently of an operation of playing a specific span of the moving picture. It is preferable that the search target text acquired from the UCC tags be transmitted to the advertisement search server 500, the search target text being acquired in sections, in which the number of search target text, extracted using the methods 1), 2), and/or 3) in the start section of the moving picture, in the end section of the moving picture, and/or in the process of playing the moving picture, is smaller than a preset number (when a moving picture is played, there may be a specific section in which there is little voice or caption, so that it is difficult to extract text, and there may be a section in which little search target text is extracted for some other reason).

Thereafter, the advertisement search server 500 for generating search results, including advertisement-type advertising content, for search target text, will be described. As an embodiment, the advertisement search server 500 may include a keyword acquisition unit 510 for acquiring at least one keyword transmitted from outside, a keyword processing unit 520 for processing the keyword acquired by the keyword acquisition unit 510, an advertisement search engine unit 550 for performing searches using the keyword acquired by the keyword acquisition unit 510 or the keyword processed by the keyword processing unit 520, and a search results transmission unit 570 for transmitting search results. Although the presence of the keyword processing unit 520 is optional, it is preferable that the keyword processing unit 520 exist. In particular, when the search target text, generated by the search target text generation module 300, requires processing in the present invention, the keyword processing unit 520 is preferably present. The reason for this is that there are generally many cases where a search keyword advertisement, included in the advertisement search server 500, is different from a keyword input by a user, and this is similar to the search target text generated by the search target text generation module 300 of the present invention. The advertisement search engine unit 550 may further include an advertisement search unit 552 for directly performing searches, and an advertisement search index 554 and an advertising content DB 556, which are objects to be inquired about by the advertisement search unit 552 using a search query. Here, in the case in which a search is performed using a search engine method, a method of searching the advertising content DB 556 for the presence and location of specific advertising content using the advertisement search index 554 is adopted. Meanwhile, a method of directly inquiring of the advertising content DB 556 using a DB query and a Database Management System (DBMS) or another method may be employed. Here, in order to improve the question-answering speed, at least one specific field of the advertising content DB 556 may be indexed. In this case, although the advertising content DB 556 is logically inside the advertisement search server 500, the advertising content DB 556 may alternatively be outside the advertisement search engine unit 550. Further, the advertisement search server 500 may further include an advertisement evaluation unit 560 for evaluating each advertisement or piece of advertising content. An example of a method of the advertisement evaluation unit 560 evaluating an advertisement will be described in an advertisement evaluation method for “Prada” and “bag” below.

When the search results transmission unit 570 transmits the search target text to at least one advertisement search server 500 capable of providing the search results, including advertising content, the advertisement search server 500 searches for the received search target text, and generates search results including advertising content. Here, the search results, including advertising content generated by the advertisement search server 500, do not exclude search results including non-advertisement-type advertising, but search results including advertisement-type advertising content are more preferable. The search results including the advertisement-type advertising content may be the search keyword advertising content of an advertiser, which corresponds to a search keyword registered by the advertiser. The search keyword advertising content of an advertiser may be formed in text, such as ‘AdWord’ of ‘google.com’, or it may be formed as a non-text type image advertisement (an advertisement which is not formed in text, such as a banner, a moving picture, or a Flash file). The reason for this is that, when an advertiser cause the search keyword to correspond to the non-text type advertising content, the non-text type advertising content corresponding to the search keyword can be extracted.

In the example, when “Prada” and “bag” are transmitted to the advertisement search server 500, the advertisement search server 500 can generate search results, including the advertisement-type advertising content, for “Prada” and “bag”. Generally, the search results including the advertisement-type advertising content may be the advertising content of the advertiser under the condition that the advertiser pays preset cost for “Prada” and “bag”. When a searcher inputs “Prada” or “bag” as a keyword, the advertiser performs search keyword advertisement using a method of paying the cost for the display of an advertiser's advertising content when the advertiser's advertising content is displayed, or paying the cost for the display of a specific Web site or Web page, linked to the advertiser's advertising content, by receiving an action of the searcher, for example, clicking on the advertiser's advertising content after the advertiser's advertising content is displayed.

Here, the following four problems may arise in connection with the advertisement search server 500. The first is that the advertisement search server 500 may provide two or more search results including advertisement-type advertising content. In this case, the problem is whether to transmit all the search results to the CS moving picture player 100 or to transmit only a predetermined number of search results to the CS moving picture player 100. That is, it is a problem related to the amount of advertising content to be transmitted. The second is related to how many search results, including advertising content, should be provided for “Prada” and “bag” when search results including advertising content for “Prada” and “bag” must be simultaneously provided. That is, it is a problem related to the distribution of a plurality of requests. In detail, when the provision of search results including advertising content for “Prada” and “bag” are simultaneously requested by the CS moving picture player 100 (or are simultaneously requested in a preset time band, because the search results including advertising content may be switched in the CS moving picture player 100 in real time, but may also be switched at least at preset time intervals), the problem of 1) determining the priority of the provision of search results including advertising content and 2) the problem of determining the number of search results including advertising content for “Prada” and “bag” must be solved.

An example of a method of solving the first and second problems may be as follows. First, the number of search results, including advertising content, requested by the CS moving picture player 100 is determined as a restrictive requirement, and the restrictive requirement for the number of search results is not exceeded. Of course, the advertisement search server 500 can transmit the preset number of search results including advertising content using its own method without considering the restrictive requirement, and the CS moving picture player 100 can adjust the number of search results including advertising content to be displayed to the user based on its own situation.

The advertisement search server 500 may be aware of 1) advertising cost per display and/or click of at least one piece of advertising content of an advertiser, and 2) a ratio of clicks to displays when the advertising content is displayed, for the respective acquired search target text. Therefore, when only 1) the advertising cost per display and/or click applies, the advertisement search server 500 can maximize advertisement revenue as the advertising cost per display and/or click increases, and, when both 1) the advertising cost per display and/or click and 2) the ratio of clicks to displays simultaneously apply, the advertising cost per display and/or click * the ratio of clicks to displays will be the expected value of advertising cost to be paid for in the case in which the advertisement is paid for when the advertisement is clicked. Therefore, the advertisement search server 500 can generate search results, including advertising content, to be transmitted to the CS moving picture player 100 by calculating the expected value of the advertising cost for each search advertisement keyword for at least one piece of search target text to be received, and by combining the search results including advertising content for 1) each search advertisement keyword or 2) for two or more search advertisement keywords based on the ascending rank of the expected values. Of course, when the advertising content of each advertiser is transmitted to the CS moving picture player 100, information about the advertising cost for each piece of advertising content and/or about the ratio of clicks to displays for each piece of advertising content can be transmitted, and the CS moving picture player 100 can display each piece of advertising content to users by determining whether to display advertising content, the order of advertising content to be displayed, and the time for display.

The above-described embodiment is shown in FIG. 23. The search target text is received from the mediation server 600 (the CS moving picture player 100) at step S610, the search target text is processed at step S620, advertisement search is performed using the processed search target text at step S630, the advertising content of advertisement search results is evaluated at step S640, ranking information is applied to the evaluated advertising content, and thus the resulting advertising content is transmitted to the mediation server 600 (the CS moving picture player 100) at step S650. Here, the processing of the search target text may be omitted. The processing of a search target is, in the case in which the search target text is not a noun, such as the name of a product or service, or a character string that cannot be easily accepted by the advertisement search server, 1) changing the search target text to a character string that can be easily accepted by the advertisement search server, or 2) replacing the search target text with a closely related character string even though the character string is not included in the search target text or is not consistent with the search target text, and then performing a search using the character string.

As an example of such processing, when the sentence “Hot weather is forecast for today” is acquired as search target text, the text “hot weather” of the sentence is processed, and then processed text which is related to hot weather, such as ice-cream, is generated. Such detailed processing for search target text can be performed using a plurality of results in a natural language processing research.

The following table is an example thereof. It is assumed that the search target text/search advertisement keywords are “Prada” and “bag”. This is a model adopted as an example, and application can be easily performed by those skilled in the art even when the number of search target text/search advertisement keywords is different from this example.

TABLE 1

| Search target | | | | |
|---|---|---|---|---|
| text/Search | | Advertising | | Expected |
| advertisement | | cost | Ratio of clicks | value |
| keyword | Advertiser | (dollars) | to displays (%) | (dollars) |
| Prada | A | 5 | 20 | 1.0 |
| Prada | B | 4 | 10 | 0.4 |
| Prada | C | 3 | 40 | 1.2 |
| Prada | D | 2 | 15 | 0.3 |
| bag | E | 3 | 30 | 0.6 |
| bag | F | 2 | 20 | 0.4 |
| bag | G | 1 | 30 | 0.3 |
| bag | H | 0.5 | 20 | 0.1 |
| Prada bag | I | 10 | 10 | 1.0 |
| Prada bag | J | 7 | 20 | 1.4 |
| Prada bag | K | 5 | 20 | 1.0 |
| Prada bag | L | 3 | 25 | 0.75 |

Here, in the case in which the search target text/search advertisement keyword is “Prada,” it is most preferable that the advertising content of an advertiser C, the expected value of which is the highest, be displayed first. In the case in which two pieces of advertising content should be displayed, selecting the advertising content of the advertisers C and A is reasonable. Of course, if advertisement content, the advertising cost of which is highest, must be displayed based on the advertisement display policy of the advertisement search server 500, the display order becomes A, B, C, and D.

In the case in which the advertising content for both “Prada” and “bag” is displayed by being combined and the number of advertisers is three, it is reasonable to display the advertising content of advertisers C, A, and E. That is, it is preferable that the advertising content of the advertiser E be displayed for “bag” than that the advertising content of the advertiser B be displayed for “Prada”.

If, there are advertisers having advertising content related to “Prada bag” and the search target text/search advertisement keywords are “Prada” and “bag”, it is most preferable that the advertising content of the advertiser J be displayed. Here, if any one of the advertisers A, I, and K, the expected values of which are the same, should be included, an internally selected policy (generally, it is preferable that the advertising content of two advertisers I and K, the search advertisement keywords of which are the same, be displayed, and the advertiser I, the price of which is high and the advertising cost of which is high, may be displayed therebetween according to the policy) may be adopted, or the advertising content of the advertisers can be displayed in rotation.

Of course, here, in the case in which the CS moving picture player 100 determines whether to display the advertising content and the ranking thereof, provides the search target text/search advertisement keyword to two or more advertisement search servers 500, shares advertisement revenue based on the display of search results, including advertising content, or clicks for displayed search results, including advertising content, and the respective advertisement search servers 500 have different revenue share ratios, the CS moving picture player 100 can select the advertisement of an advertiser, the expected value of which is highest based on the CS moving picture player 100, in consideration of the revenue share ratios in the above example. That is, the CS moving picture player 100 does not display all of the advertising content before the received advertising content is displayed, as described above, but performs filtering based on preset criteria, and displays only advertising content passed through the filtering. The advertisement display module 400 includes the criteria for the filtering.

The CS moving picture player 100 for displaying search results, including advertisement-type advertising content, (the advertisement display module 400 included in the CS moving picture player 100 can perform this function) can display the received advertising content to a user based on its own policy. That is, the present invention includes a process of displaying advertising content based on text information that can be acquired from a moving picture which is played in a process of playing the moving picture, so that, when search results including advertising content are displayed, the search results including advertising content to be displayed may be insufficient in a specific time band (the playback of a moving picture requires the passage of time, and if the passage of time is interpreted from the point of view of a period or band, the passage of time can be considered to be a time band) due to the insufficiency of acquired text or for some other reason as noted above. Here, the advertisement display module 400 of the CS moving picture player 100 may adopt 1) a method of displaying search results by combining search results including advertising content in a previous time band with search results including advertising content in a current time band, 2) a method of replacing the oldest search results including advertising content in the previous time span with search results including advertising content generated in a current time span, and 3) a method of completing search results including insufficient advertising content with advertising content related to text based on UCC tags because the advertising content related to text based on UCC tags has no relationship with the time band at which a moving picture is played.

Of course, although it has been described that the CS moving picture player 100 displays the advertising content as search results including received advertising content, the case where the advertisement display module 400, functioning as a program executed in combination with or in conjunction with the CS moving picture player 100, performs the display function is not excluded. That is, the relationship between the advertisement display module 400 and the CS moving picture player 100 includes 1) the case in which they are both included in the same program, managed by the same service provider (they are combined with each other), 2) the case in which they operate as separate programs, which are managed by the same service provider (they are in conjunction with each other), 3) the case in which they operate as separate programs, which are managed by respective service providers, but cooperate with each other by performing communication therebetween (as an example of such conjunction, the CS moving picture player 100 has control rights for a file played by itself, and the player provides information, acquired from the file controlled by itself, to the module), and 4) the case in which they are operated by separate service providers, and the module independently perceives files (the files exist in the user computer 10) played by the CS moving picture player 100 and separately performs its function. Of course, when the Web moving picture player 100-1 method is used, generally only the cases 1), 2), and 3) are possible. Although the function of the module is described as the function of the player for convenience of description in the present specification, this is only an example, and it will be apparent that all of the cases 1), 2), 3), and 4) of this paragraph are included.

The operation performed by the advertisement display module 400 will be summarized and sequentially described in the following: First, the advertisement display module 400 acquires advertisement search results at step S310, performs filtering on the advertisement search results based on predetermined criteria, such as the number of advertisements and the advertising cost, at step S320, synchronizes the filtered advertisement search results with the moving picture that is being played at step S330, and displays the synchronized advertisement search results at step S340. Of course, the filtering process at step S320 may be omitted if necessary.

Further, it is most preferable that the text acquisition module, the search target text generation module 300, and the advertisement display module 400 be operated by the same unit. In particular, the text acquisition module and the search target text generation module 300 should be operated by the same unit. Although it is preferable that the operating unit of the advertisement display module 400 and the operating unit of the moving picture player be the same, they may be different. In the case in which the operating unit of the text acquisition module is different from the operating unit of the moving picture player, the advertisement display module 400 may function as an Application Service Provider (ASP) for providing its service to the party that provides at least one moving picture player service. That is, the party that operates the advertisement display module 400 can display its own service to a user using its advertisement display module 400 in conjunction with a plurality of moving picture players. Here, it is preferable that the party that provides the advertisement display module 400 provide the text acquisition module and the search target text generation module 300 to the ASP. In the case in which the moving picture player is a Web moving picture player 100-1, the ASP can be more easily combined because the Web moving picture player 100-1 operates on the Web site or Web server of a specific service provider.

Although the situation in which a moving picture is played by the CS moving picture player 100 has been assumed and described, it will be apparent to those skilled in the art that the situation is the same as the situation in which a moving picture is played by the Web moving picture player 100-1. That is, other than the fact that the moving picture player 100 is operated on a personal computer, since the function performed by the CS moving picture player 100, installed and executed in the user computer 10, is performed by a server (an arbitrary server, such as a Web site and a Web server, in which a moving picture player is operated) on which the Web moving picture player 100-1 is executed, there is no difference in the essential configuration therebetween. This will be described in further detail with reference to the following embodiment.

Now, synchronization between a moving picture played by the player and advertising content based on text information acquired from the moving picture will be described. In order to induce a user to take action related to advertising content, such as paying attention to advertising content or clicking on the advertising content, it is preferable that advertising content related to text which forms caption information (the caption information includes translated caption information), displayed when the specific scene of the moving picture is played. Therefore, it is required that the caption information, which changes every moment, be synchronized with the advertising content.

It is preferable that the synchronization be implemented using any one of the following three methods.

The first method is characterized in that the acquisition of text information is synchronized with search results including advertising content in real time. For a moving picture, that is, a moving picture that is being played at a specific time point, search results including advertising content is acquired using a method of inquiring of at least one advertisement search server 500 capable of acquiring text information from a caption within a time span (or a frame span) including the specific time point, acquiring search target text from the acquired text information, and providing search results including advertising content for the acquired search target text. The acquired search results including advertising content can be displayed on the lower portion, the left or right sides, or the predetermined portion of the player in which the moving picture is being played. According to this method, the acquisition of search target text within a specific time span (or a frame span) is synchronized with the display of search results including advertising content in real time. This method is different from the second method, which will be described later, in that text information can be acquired in real time using a voice recognition method instead of using a caption, and thus this method can be used when the voice recognition method is adopted.

The second method is to obtain and store text information and search results including advertising content first, and then to display the advertising content when the acquired text information is displayed as a caption. For a moving picture, that is, a moving picture that is being played at a specific time point, search results including advertising content is acquired and stored using a method of inquiring of at least one advertisement search server 500 capable of acquiring text information from a caption corresponding to a period including the specific time point, before the time span (or the frame span) including the specific time point, acquiring search target text from the acquired text information, and providing search results including advertising content for the acquired search target text. The stored advertising content is displayed in synchronization with the caption or caption information at a time point or in a time span (or a frame span) at which the caption or the caption information, related to the text information, should appear. Here, it is preferable that the advertising content be stored together with the time point or the time span (or the frame span) information. That is, it is preferable that the advertising content be stored together with the time span (or the frame span) information is stored in the form of meta tags or in the form of information, which can be recognized by the advertisement display module 400. It is preferable that the advertising content be displayed on the lower portion, the left or right sides, or the predetermined portion of the player in which the moving picture is being played. This method is different from the third method, which will be described later, in that the difference between the time point at which the advertising content is acquired and the time point at which the specific part of a moving picture, in which a caption related to the advertising content is displayed, is small (the former is slightly later than the latter, and it is preferable that the difference therebetween ranges from 1 to 10 time spans (or frame spans), if possible).

A third method, since a caption is in the form of a file, is to process text information included in all caption files in the time span unit based on time span (or frame span) unit information included in the caption, obtain search results including advertising content corresponding to the text information in the time span unit, and then store the acquired search results together with the time span information. Here, when the moving picture is played, the advertisement display module 400 can display the advertising content by synchronizing time span information, included in the moving picture to be played at a specific time point, with the time span information, included in the advertising content.

Sites, such as ‘youtube.com’ and ‘pandora.tv’, which handle so-called UCC moving pictures, provide service of uploading moving pictures, taken or acquired by users, as UCCs, and playing the uploaded moving pictures using a Web moving picture player 100-1. The characteristic of the UCC moving picture is that the playback time thereof is short, unlike a movie. That is, the following methods can be applied to UCC moving pictures.

First, in the case in which text is acquired using a voice recognition method, 1) a method of the advertisement display module 400 providing advertising content in synchronization with a UCC moving picture that is being played, like a movie, or 2) a method of displaying advertising content, based on search keyword advertisement acquired using a method according to the present invention, separately from the UCC moving picture that is being played when the playback of a UCC moving picture starts or the playback of the UCC moving picture ends can be performed. In particular, when the playback of the UCC moving picture ends, the advertising content can be collected and then displayed.

Second, in the case in which text information, included in the UCC tags of a UCC moving picture, is acquired and then advertising content based on the text information included in the UCC tags is displayed, a method of displaying the advertising content separately from the UCC moving picture that is being played 1) when the playback of a UCC moving picture starts, 2) when the UCC moving picture is being played, or 3) when the playback of the UCC moving picture ends can be performed. In particular, when the playback of the UCC moving picture ends, the advertising content can be collected and then displayed.

Although this method is most suitable for a caption formed in text or a caption file, it may also be applied to a voice recognition method. For this purpose, a step of preprocessing a moving picture to be played by a player is required at step S210. The preprocessing can be performed using a method of playing the moving picture file, acquiring text information from the voice information of the moving picture that is being played, and storing one or more selected from among 1) the text information itself, 2) search target text next to the search target text acquired from the text information, and 3) search results including advertising content as the search target text, based on the acquired text information, in accordance with the information about the play time span of the moving picture. The advertising content in synchronization with the moving picture is provided to users as a result by selecting one from among 1) the text information itself, 2) search target text next to the search target text acquired from the text information, and 3) search results including advertising content as the search target text.

The preprocessing of the moving picture may be performed by preprocessing the moving picture file itself, and the moving picture file itself may include 1) the preprocessed text information itself, 2) the search target text next to the search target text acquired from the text information, and 3) the search results including advertising content as the search target text. Further, in the case in which the moving picture is played on a server using a Web moving picture player 100-1, the preprocessing of a moving picture must be performed before the Web moving picture player 100-1 plays the moving picture and transmits it to a user, using a method such as a streaming method, and 1) the preprocessed text information itself, 2) the search target text next to the search target text acquired from the text information, and 3) the search results including advertising content as the search target text must be stored in conjunction with the moving picture file.

Thereafter, the present invention will be described in further detail with reference to a preferred embodiment. Before this embodiment of the present invention is described, common elements will be described again. In order to implement the spirit of the present invention, 1) a text information acquisition module 200 for extracting text from a moving picture, 2) a search target text generation module 300 for generating search target text from text information acquired by the text information acquisition module 200, 3) an advertisement search server 500 for generating search results, including advertisement-type advertising content, for the search target text, 4) a moving picture player for playing a moving picture for users, and 5) an advertisement display module 400 for displaying the search results including the advertisement-type advertising content, are required.

Various types of embodiments can be proposed depending on how and when the modules 1) to 3) are performed, and who performs them, and whether modules 4) and 5) are used by a CS method or a Web method, and the operating units thereof are the same. Since the relationship between modules 4) and 5) from the view of units has been described above, no additional description thereof will be given except for special cases. Since the functions performed by respective modules, such as the text information acquisition module 200, the search target text generation module 300, and the advertisement display module 400, have been sufficiently described above, this embodiment will be described focusing on the configuration centering on entire configuration units and the range of the modules included by the respective units.

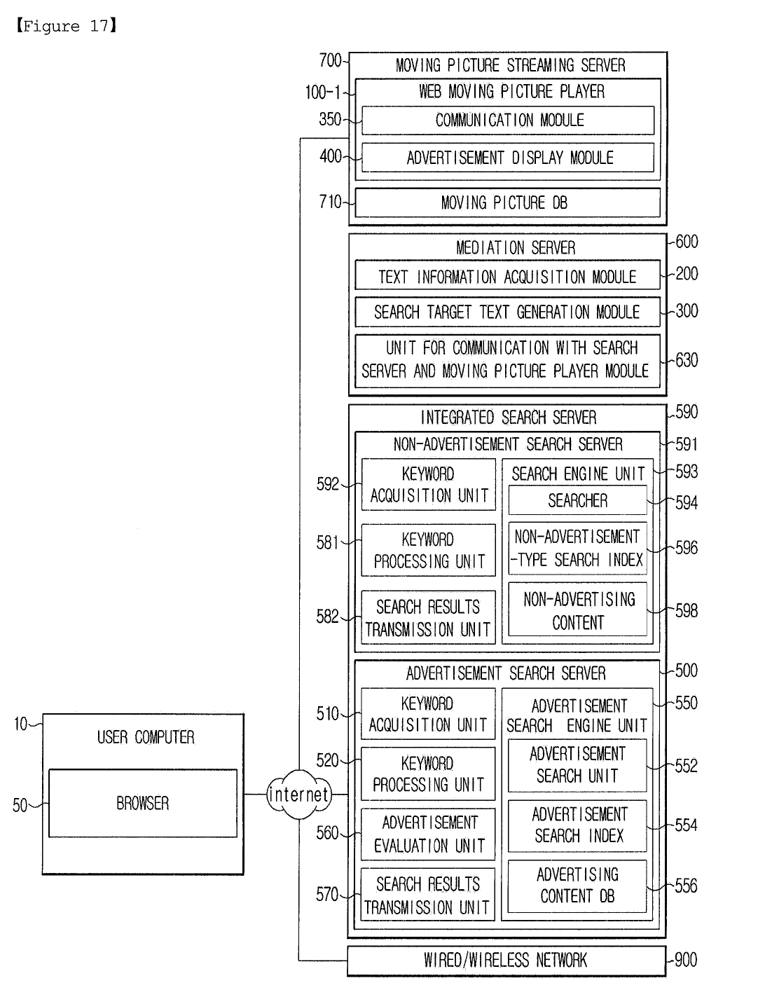

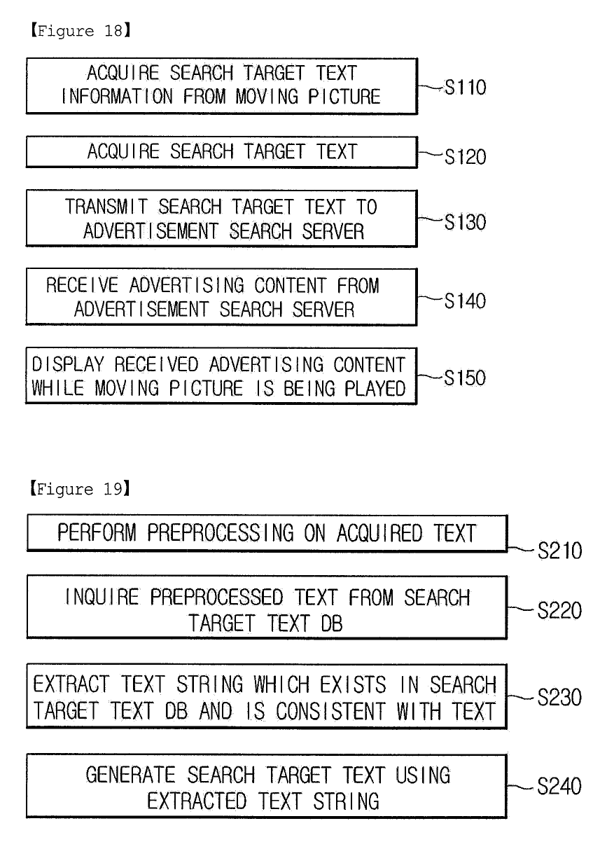

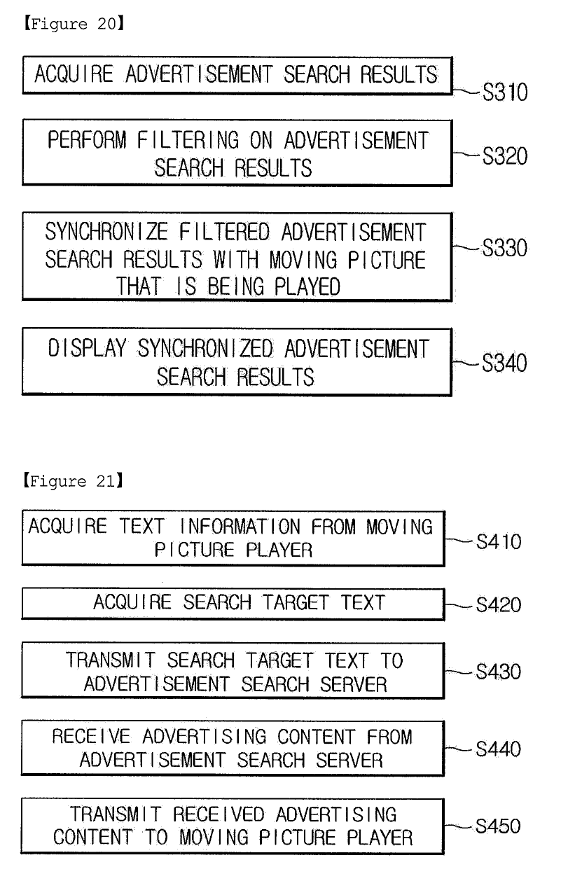

FIG. 5 shows the system configuration related to an embodiment in which the CS moving picture player 100 includes the text information acquisition module 200, the search target text generation module 300, and the advertisement display module 400. In this case, a configuration, as an embodiment of the present invention, characterized in that the CS moving picture player 100 acquires text information, generates search target text information, and communicates with the advertisement search server 500, and the advertisement display module 400 displays the advertising content acquired from the advertisement search server 500 is shown. FIG. 18 shows a flowchart showing the flow of information processing based on the CS moving picture player 100 of the system of FIG. 5.

It is preferable that the advertisement search server 500 is the server (the server of a business which does not provide service, such as a search portal, by itself, unlike ‘overture.com’ or ‘overture.co.kr’ but performs advertising by providing advertisement search results for other Web sites) of a search advertisement agency. Of course, the advertisement search server 500 may be a server, such as ‘google.com’ or ‘naver.com’, which provides integrated search results. Here, in the case in which the provision of non-advertisement search results is limited when the CS moving picture player 100 communicates with a server, such as ‘google.com’ or ‘naver.com’, which provides integrated search results, the advertisement search server 500 can perform the same function as the server of a search advertisement agency, and the operator of the server, such as ‘google.com’ or ‘naver.com’, which provides integrated search results, is generally engaged with a search advertisement agency or has a partnership therewith. The content of this paragraph can correspond to all advertisement search servers 500, which have been described above and which will be described later. In order to avoid unnecessary redundant description, the description of the advertisement search server 500 in this paragraph will be omitted in subsequent descriptions.

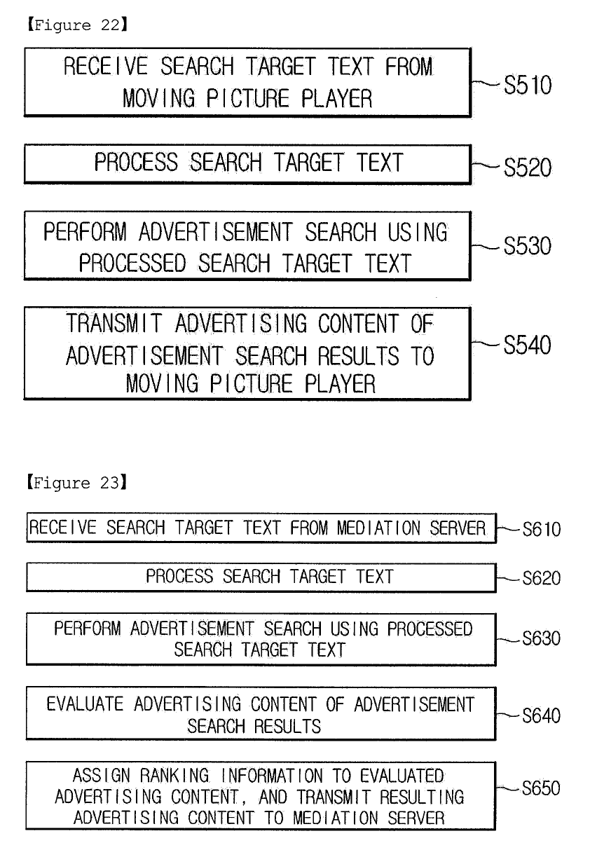

An embodiment of the operation method of the advertisement search server 500 is shown in FIG. 22. The advertisement search server 500 receives search target text from the moving picture player step S510, processes the search target text at step S520, performs an advertisement search using the processed search target text at step S530, and then transmits the advertising content of the advertisement search results to a moving picture player at step S540. Here, the processing of the search target text can be omitted. The processing of the search target has been described above.

The system configuration shown in FIG. 5 has an advantage of excellent efficiency and integration because all the functions are integrated in the CS moving picture player 100, so that the party that supplies the CS moving picture player 100, either with or without compensation, can organically integrate desired functions of the text information acquisition module 200, the search target text generation module 300, and the advertisement display module 400.

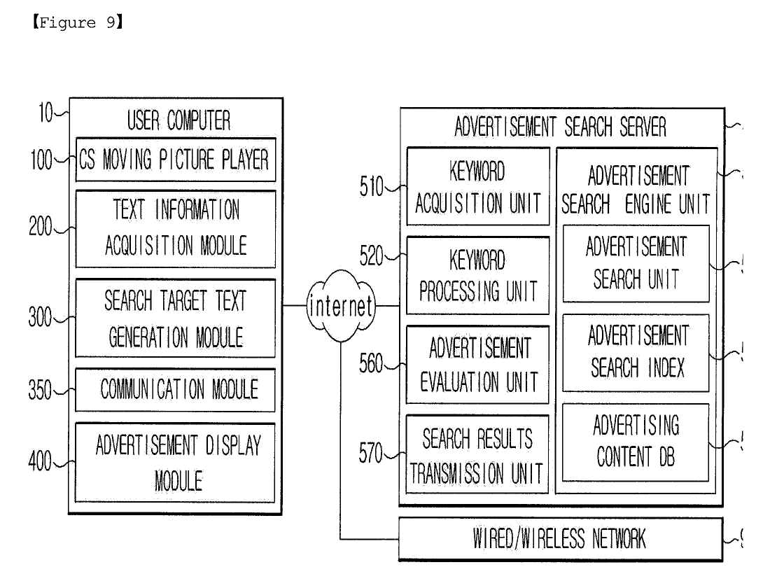

FIG. 9 shows the system configuration of an embodiment in which the modules are not included in the CS moving picture player 100 but the CS moving picture player 100, the text information acquisition module 200, the search target text generation module 300, and the advertisement display module 400 work in conjunction with each other while having an equal relationship. Here, although the party that manages the CS moving picture player 100, the text information acquisition module 200, the search target text generation module 300, and the advertisement display module 400 may be the same party, the CS moving picture player 100, the text information acquisition module 200, the search target text generation module 300, and the advertisement display module 400 may be managed by different units. The example of the different units may include the mediation server 600, the advertisement search result provision server, and a server that manages a third ASP service. This model has an advantage in that the possibility that a plurality of service providers can cooperate with a plurality of moving picture player service providers increases.

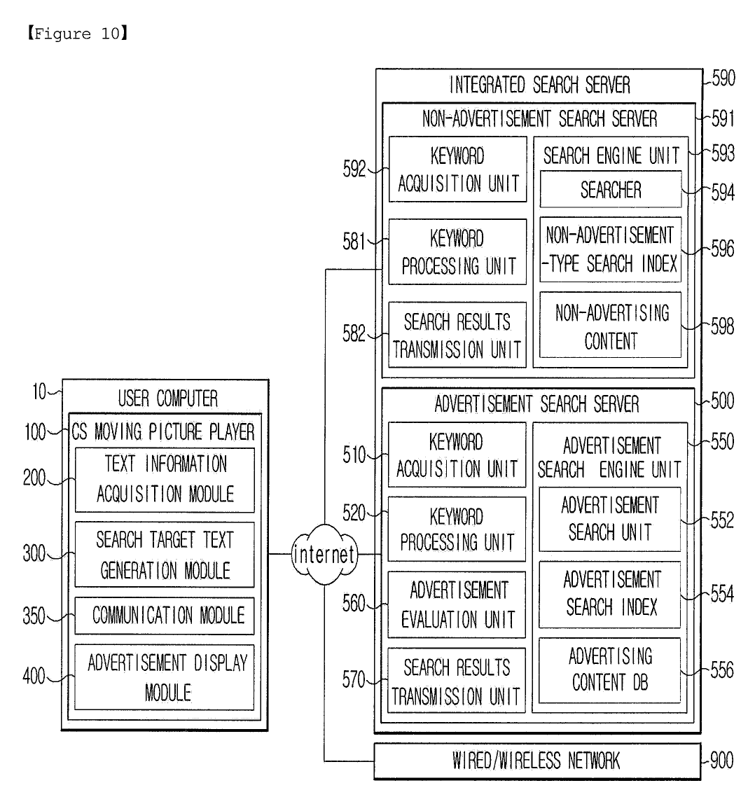

FIG. 10 shows a system configuration in which the text information acquisition module 200, the search target text generation module 300, and the advertisement display module 400 are included in the CS moving picture player 100, or in which they are organically associated with each other even though the text information acquisition module 200, the search target text generation module 300, and the advertisement display module 400 are not included in the CS moving picture player 100, and in which the advertisement search server 500 is an integrated search server 590, such as a portal (‘naver.com’ or ‘yahoo.com’), so that the integrated search server 590 includes a non-advertisement search server 591 and an advertisement search server 500. The non-advertisement search server 591 generally includes a keyword acquisition unit 592 for receiving a keyword, a search engine unit 593 for performing searches, a keyword processing unit 581 for processing the keyword, and a search results transmission unit 582 for transmitting found results. The search engine unit 593 may include a searcher 594 for actually performing searches on a non-advertisement-type search index 596, and a non-advertising content 598. The relationship of the non-advertisement search server 591 and the spirit of the present invention resides in the fact that the non-advertisement search server 591 provides non-advertising content, rather than advertising content, when it is related to the CS moving picture player 100 or the Web moving picture player 100-1. That is, the non-advertisement search server 591 generates non-advertisement-type search results, and transmits the non-advertisement-type search results to the CS moving picture player 100 or the Web moving picture player 100-1. When the CS moving picture player 100 or the Web moving picture player 100-1 plays the moving picture, the CS moving picture player 100 or the Web moving picture player 100-1 can provide the received non-advertisement search results in synchronization with the played moving picture.

Although the advertisement search server 500 is included in the integrated search server 590, the advertisement search server 500 may be a server implemented in the form of an ASP having the function of the server (for example, a server such as ‘overture.com’) of an external search advertisement agency, a server leased from an external search advertisement agency, or a server configured to provide advertisement search results by communicating with the server of an external search advertisement agency. The configuration applies in the same manner if the integrated search server 590 is described later, and thus a duplicated description will be omitted in order to avoid redundancy.

In the case of conjunction, although the party that manages the CS moving picture player 100, the text information acquisition module 200, the search target text generation module 300, and the advertisement display module 400 may be the same party, they may be managed by different units. That is, the text information acquisition module 200, the search target text generation module 300, and the advertisement display module 400 can be managed by different parties. As long as the modules perform smooth communication with the respective counter parties thereof, the users have no interest in the identity of involved service providers. Further, the different units may include the mediation server 600, the advertisement search result provision server, the server of a search advertisement agency, and a server which manages a third ASP service. The content, which has been described in this paragraph as being generally applied to the CS moving picture player 100, the text information acquisition module 200, the search target text generation module 300, and the advertisement display module 400, can be applied to all systems which have been described above, and can be applied to all systems which will be described later, and thus a description thereof will be omitted in order to avoid redundancy. Of course, the content of this paragraph is applied to the case in which the CS moving picture player 100 is replaced by the Web moving picture player 100-1. In the case of the Web moving picture player 100-1, the content of this paragraph is easily applicable due to the internetworking characteristic of the Web. Therefore, a description of the Web moving picture player 100-1 will be omitted in order to avoid redundant description.

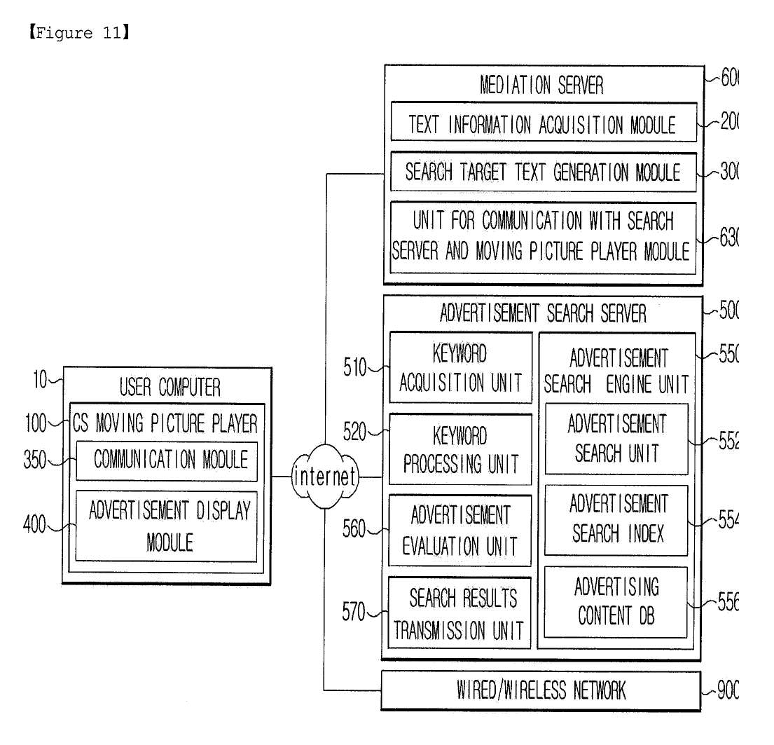

FIG. 11 shows a model, as an embodiment, in which the CS moving picture player 100 and the mediation server 600 divide tasks therebetween. The drawing shows a configuration in which the mediation server 600 performs the functions of the text information acquisition module 200 and the search target text generation module 300, and the CS moving picture player 100 performs the function of the advertisement display module 400. In order for the mediation server 600 to perform the function of the text information acquisition module 200, it will be apparent to those skilled in the art that the transmission of the moving picture itself, the caption file of the moving picture or the translated caption file of the moving picture, or the UCC tags of the moving picture to the mediation server 600 should be assumed. Although the advertisement display module 400 is not managed by the mediation server 600 in FIG. 11, a configuration in which the advertisement display module 400 is managed by the mediation server 600 can be acquired. Further, unlike the configuration shown in FIG. 11, the mediation server 600 can perform only the functions of the search target text generation module 300 and the advertisement display module 400, while the mediation server 600 does not perform the function of the text information acquisition module 200. Further, a model in which the mediation server 600 performs only the function of the advertisement display module 400 can be provided. Here, the mediation server 600 can concentrate on a role of efficiently displaying advertising content which arrives at the CS moving picture player 100. It is apparent that the role of the mediation server 600, which has been described in this paragraph, can be applied to the role of the mediation server 600 in another configuration of the present specification and drawings. Therefore, a description of the role of the mediation server 600 will be omitted in order to avoid redundant description.

The flow of the function performed by the mediation server 600 will be described below. The mediation server 600 can be operated in such a way that the text information acquisition module 200 acquires text information from the moving picture player at step S410, the search target text generation module 300 acquires search target text from the text information at step S420, the text information acquisition module 200 and the search target text generation module 300 being included in the mediation server 600, the search target text is transmitted to the advertisement search server 500 at step S430, advertising content is received from the advertisement search server 500 at step S440, and the received advertising content is transmitted to the moving picture player at step S450.

FIG. 12 is shows a system configuration to which the mediation server 600 and the integrated search server 590 are related. Since the mediation server 600 and the integrated search server 590 have been sufficiently described above, a description thereof will be omitted in this paragraph.

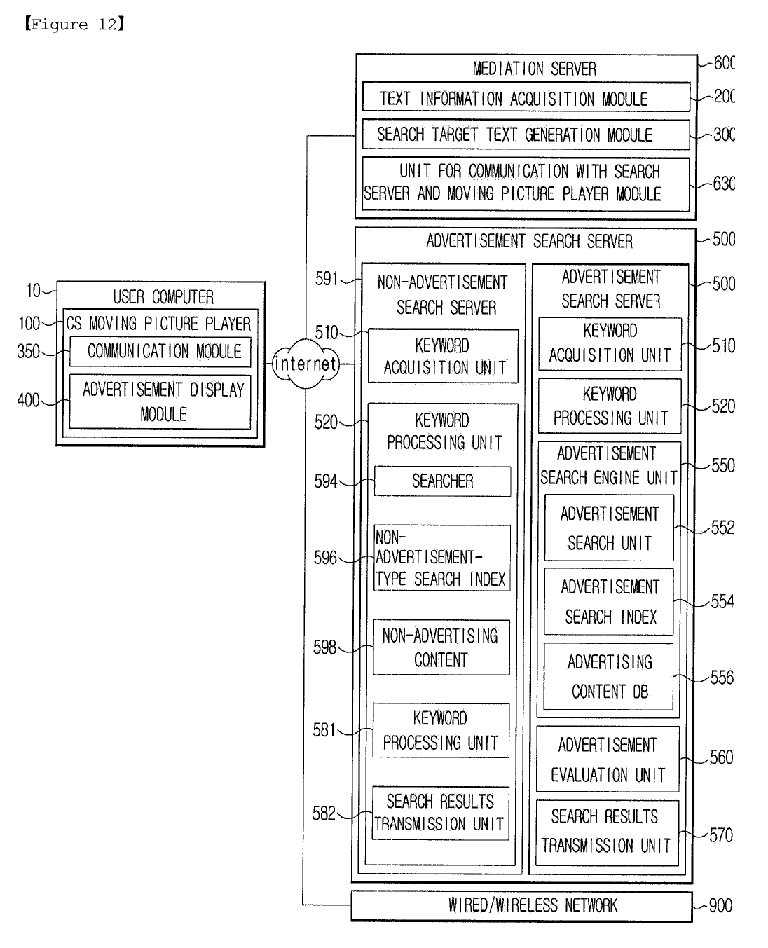

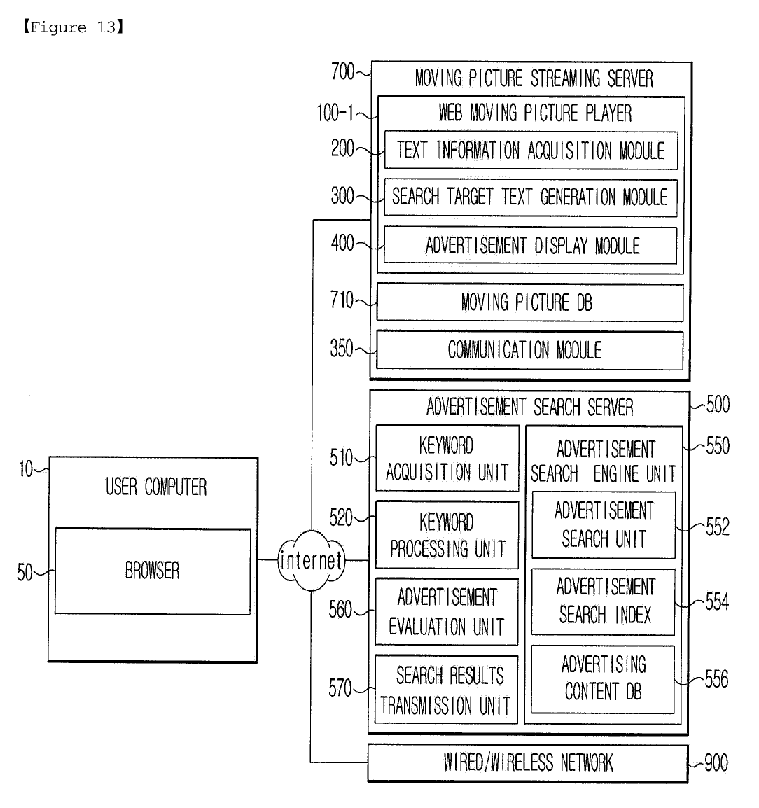

FIGS. 13 to 17 show a system configuration in which the CS moving picture player 100 is replaced by the Web moving picture player 100-1. In the overall configuration, the modules correspond respectively to the modules of FIGS. 9 to 12 in a one-to-one manner, with the exceptions that the CS moving picture player 100 is replaced by the Web moving picture player 100-1, and that a moving picture streaming server 700 for playing a moving picture and then transmitting it to the user computer 10 is adopted. In order for a moving picture, played on a Web server, to be transmitted to a user, a Web server for playing the moving picture is required, and a process of transmitting the moving picture, which is being played, to the user computer 10, and displaying the received moving picture through a browser must be performed. Therefore, a browser must be installed in the user computer 10, other than the CS moving picture player 100, and a server (for example, the moving picture streaming server 700) for playing a moving picture is essentially required. Of course, browser add-ons (an Active X control, a Java Applet, or a Plugin program) may be installed in the user computer 10 or the browser of the user computer 10. Below, the respective modules will be described in brief, but the description of modules that are the same as in the above-described FIGS. 5 and 9 to 12 will be omitted. (Of course, it is apparent that the CS moving picture player 100 is replaced by the Web moving picture player 100-1.)

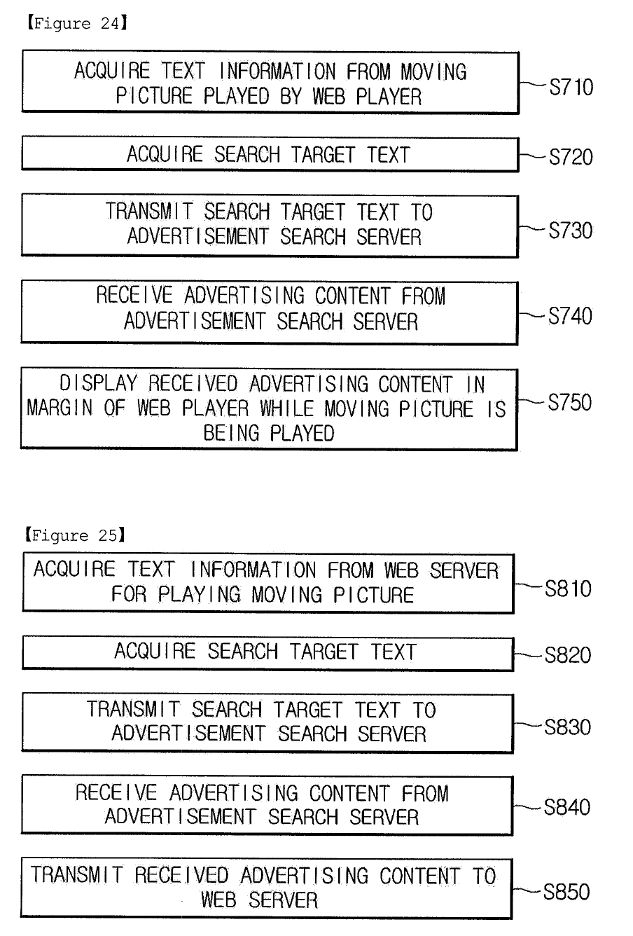

FIG. 13 shows a system configuration, as an embodiment, in which the moving picture streaming server 700 includes a moving picture player module (a Web moving picture player 100-1 module), and the Web moving picture player 100-1 module includes the text information acquisition module 200, the search target text generation module 300, and the advertisement display module 400. Here, a configuration, as an embodiment according to the present invention, characterized in that the Web moving picture player 100-1 module acquires text information, generates search target text information, and communicates with an advertisement search server 500, and in which the advertisement display module 400 displays advertising content acquired by the advertisement search server 500, is shown. FIG. 24 is a flowchart showing the flow of information based on the Web moving picture player 100-1 of the system of FIG. 13. Since the moving picture streaming server 700 generally includes a plurality of moving pictures, it commonly includes a moving picture DB 710. Further, the communication module 350 may be included in the Web moving picture player 100-1 module, or is located outside the Web moving picture player 100-1. Since the advertisement search server 500 has been sufficiently described in FIG. 5, a description thereof will be omitted in this paragraph.

An embodiment of the operational order of the moving picture streaming server 700 of FIG. 13 is well shown in FIG. 24. The moving picture streaming server 700 acquires text information from a moving picture, played by the Web moving picture player 100-1, using the text information acquisition module 200 at step S710, generates and acquires search target text using the search target text generation module 300 at step S720, transmits the search target text to the advertisement search server 500 at step S730, receives advertising content from the advertisement search server 500 at step S740, and displays the received advertising content in the margin of the Web moving picture player 100-1 in synchronization with the playback of the moving picture while the moving picture is being played at step S750.

FIG. 14 shows a configuration, as an embodiment, in which the text information acquisition module 200, the search target text generation module 300, and the advertisement display module 400 exist outside the Web moving picture player 100-1 module, and the respective modules are in conjunction with each other. Since the configuration in the case of conjunction has been sufficiently described in the description of FIG. 9, it will be omitted in this paragraph.

However, the moving picture streaming server 700 and the advertisement search server 500 may be performed by the same unit in the configuration of FIG. 14. That is, the reason for this is that a large portal, such as ‘naver.com’ or ‘yahoo.com’, can display a moving picture by streaming it inside, or can internally operate the advertisement search server 500. That is, the unit for playing a moving picture using the moving picture player does not need to be different from the unit for operating the advertisement search server 500, and this relationship is applied between a supplier for the CS moving picture player 100 and an operational unit of the advertisement search server 500.

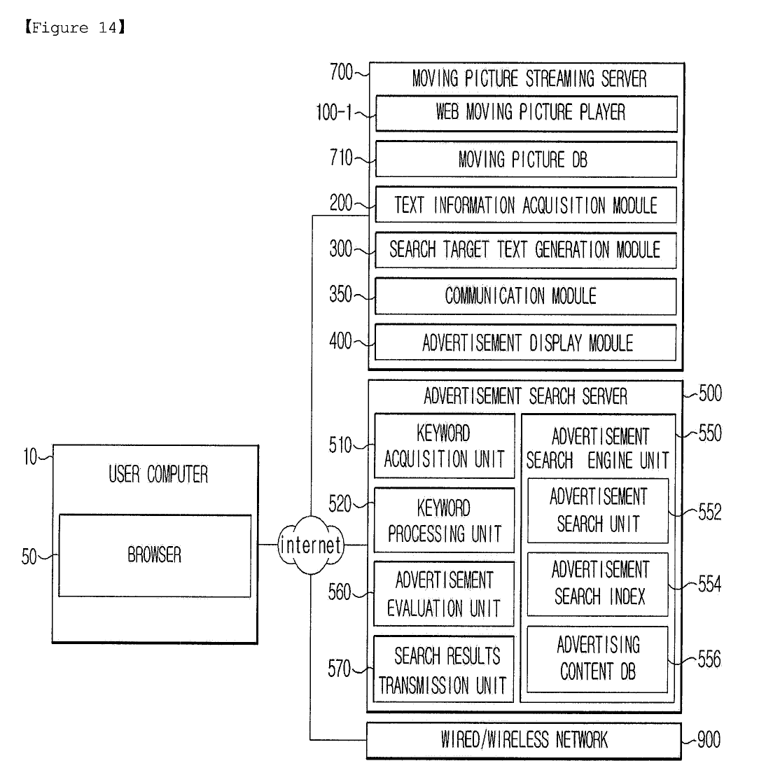

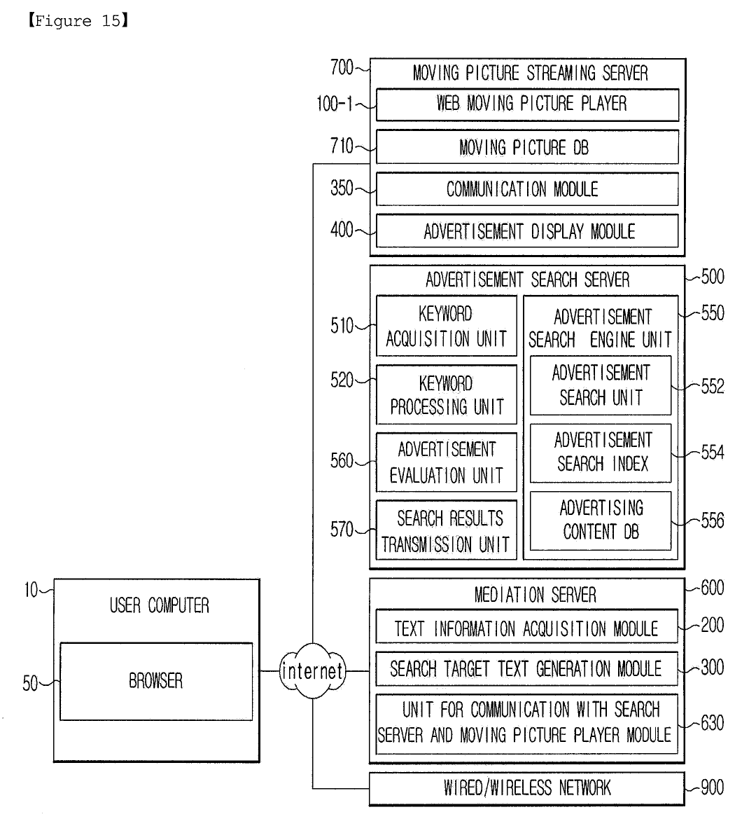

FIG. 15 shows a model, as an embodiment, in which the moving picture streaming server 700 and the mediation server 600 divide tasks therebetween. Since the description of this model is the same as the description of FIG. 11, the description will be omitted in this paragraph. An embodiment in which the mediation server 600 is operated with the moving picture streaming server 700 is well shown in FIG. 24. The mediation server 600 acquires text information from a Web server for playing the moving picture using the text information acquisition module 200 at step S810, generates and acquires search target text using the search target text generation module 300 at step S820, transmits the search target text to the advertisement search server 500 at step S830, receives advertising content from the advertisement search server 500 at step S840, and then transmits the received advertising content to the Web server at step S850.

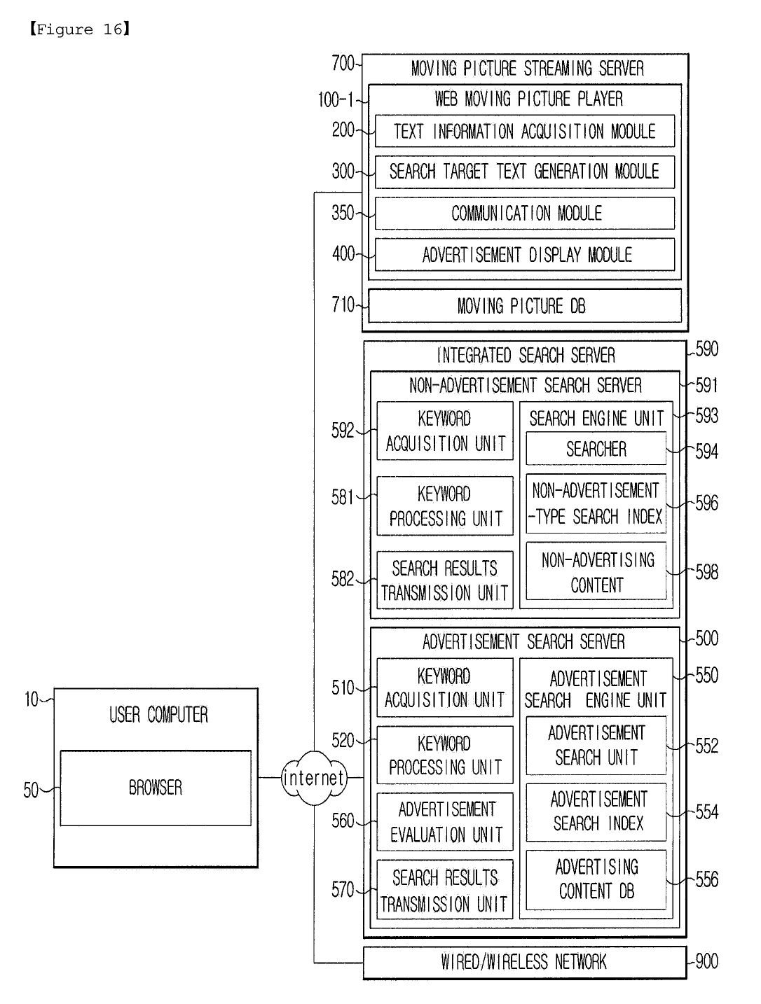

FIG. 16 shows a system configuration to which the integrated search server 590 is related. Since the mediation server 600 and the integrated search server 590 have been sufficiently described in the description of FIG. 10, a description thereof will be omitted in this paragraph. An embodiment of a method of the integrated search server 590 and the advertisement search server 500, included in the integrated search server 590, operating with the moving picture streaming server 700 is well shown in FIG. 26. The advertisement search server 500 receives search target text from a Web server for playing a moving picture at step S910, processes the search target text at step S920, performs an advertisement search using the processed search target text at step S930, and then transmits the advertising content of the advertisement search results to the Web server at step S940. Here, the processing process can be omitted and an embodiment of the processing is the same as in the above description.

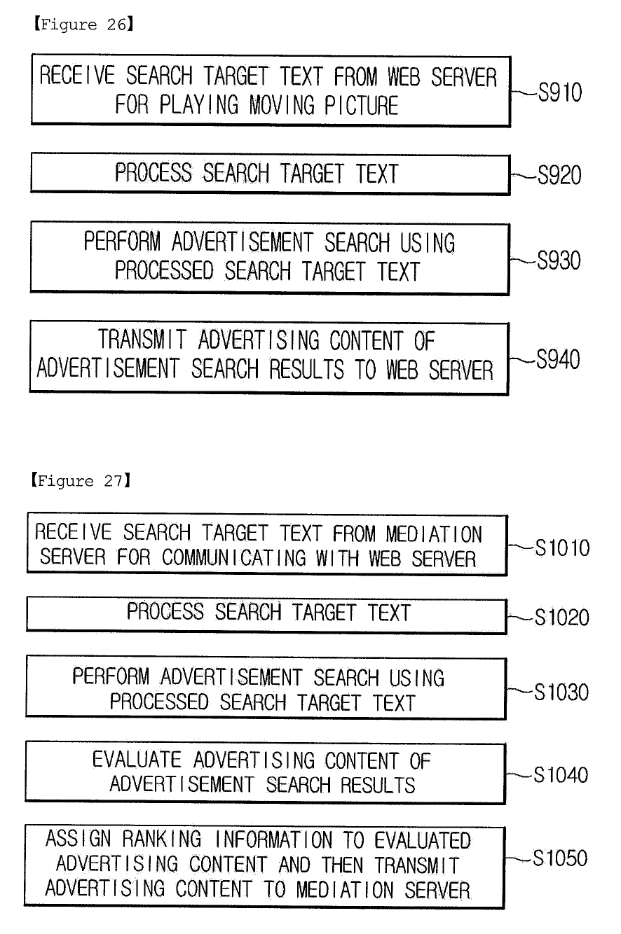

FIG. 17 shows a system configuration to which the mediation server 600 and the integrated search server 590 are related. Since the mediation server 600 and the integrated search server 590 have been sufficiently described in the above description, the description thereof will be omitted in this paragraph. An embodiment of a method of the integrated search server 590 or the advertisement search server 500, included in the integrated search server 590, evaluating the advertising content as search results, and then transmitting the evaluated advertising content to the moving picture streaming server 700 and/or the mediation server 600 is shown in FIG. 27. The advertisement search server 500 receives search target text from the mediation server 600 (the Web server) for communicating with a Web server at step S1010, processes the search target text at step S1020, performs an advertisement search using the processed search target text at step S1030, evaluates the advertising content of the advertisement search results at step S1040, assigns ranking information to the evaluated advertising content and then transmits the advertising content to the mediation server 600 at step S1050. The processing of the search target text and the evaluation of the advertising content are the same as in the above description.

Although the present invention will be described with reference to embodiments below, the embodiments correspond to some of the models in which the spirit of the present invention is implemented, and the spirit of the present invention is not limited to the embodiments below.

### First Embodiment

The first embodiment is the most basic model, the system configuration of the present embodiment is shown well in FIG. 5, and the flowchart thereof is shown in FIG. 18.

It is characterized in that the text information acquisition module 200, the search target text generation module 300, and the advertisement display module 400 are integrally combined with each other in the CS moving picture player 100. The text information acquisition module 200 acquires text from a moving picture at step S110, the search target text generation module 300 generates search target text based on the acquired text at step S120 and transmits the generated search target text to the search result provision server, including the advertising content, at step S130, the search result provision server, including the advertising content, transmits the advertising content of an advertiser to the CS moving picture player 100, the CS moving picture player 100 receives the advertising content at step S140, and the advertisement display module 400, integrated into the CS moving picture player 100, displays the advertising content at a predetermined region in accordance with the playback of the moving picture at step S150. Of course, the functions performed by the text information acquisition module 200, the search target text generation module 300, and the advertisement display module 400 may be included in any one or more functions performed by the above-described modules under the above-described various types of situations or environmental conditions.

The system configuration of the present embodiment is shown well in FIG. 5, and the flowchart thereof is shown in FIG. 18.

The advertisement search server 500 includes a server for providing a search portal service, such as a server for managing ‘google.com’, and a search advertisement agency server managed by a party that performs search advertisement, such as a server for managing ‘overture.com’.

It is preferable that the region in which the advertising content is displayed be formed in a Web page format. In addition, a measurement module for measuring displays and/or clicks for the advertising content may be further included. Of course, when the manager (including a manufacturer and/or a distribution/sale entity) of the CS moving picture player 100 has made a contract with the manager of the advertisement search server 500, the advertising content generally includes various types of information, which is not visible to a user and is used to distribute advertising costs. The information used to distribute advertising costs may include the unique number of the manager of the CS moving picture player 100 and/or the unique number of the manager of the advertisement search server 500, and the unique number of the advertising content itself. Here, if the user clicks on advertising content, the unique number of the advertising content, the fact that the click has occurred, the time at which the click occurred, and the unique information of the manager of the CS moving picture player 100 are transmitted to the advertisement search server 500, so that the advertisement search server 500 can be aware of the type of advertising content and the time at which the advertising content clicked through the manager of the CS moving picture player 100, and these facts become the basis of the distribution/settlement of the advertising cost.

In this embodiment, the text information acquisition module 200, the search target text generation module 300, and the advertisement display module 400 are organically integrated into the CS moving picture player 100, so that there is an advantage in that the party that supplies the CS moving picture player 100 to users can greatly increase the amount of advertisement revenue that it earns.

### Second Embodiment

This embodiment is the same as the first embodiment, other than the fact that the advertisement display module 400 in the first embodiment is managed by the advertisement search server 500. The advertisement search server 500 includes a server for providing a search portal service, such as a server for managing ‘google.com’, and a search advertisement agency server managed by a party that performs search advertisement, such as ‘overture.com’. That is, the CS moving picture player 100 leases space for displaying the advertising content to the manager of the advertisement search server 500 or an agent for a search advertisement, so that the manager of the advertisement search server 500 or the agent for a search advertisement fill the leased space with advertising content. Here, the advertisement display module 400 is actually managed by the manager of the advertisement search server 500 or the search advertisement agency.

### Third Embodiment

This embodiment is the same as the first embodiment other than the fact that the function that is performed by the search target text generation module 300 in the first embodiment is performed by a third mediation server 600. That is, the CS moving picture player 100 acquires text information from a moving picture, and transmits the acquired text information to the third mediation server 600. The search target text generation module 300 of the third mediation server 600 processes the acquired text information, and then transmits the resulting text information to the CS moving picture player 100. The CS moving picture player 100 transmits the acquired search target text to a search server, receives the advertising content of the advertisers, and then displays them as the search results, including advertising content, to the users.

### Fourth Embodiment

This embodiment is the same as the first embodiment other than the fact that the third mediation server 600 in the third embodiment generates search target text, transmits the search target text to a search server, receives search results, including advertising content, from the search server, and then transmits the received search results, including advertising content, to the CS moving picture player 100.

### Fifth Embodiment

This fifth embodiment is the same as the third embodiment other than the fact that the advertisement display module 400 in the third embodiment is managed by the third mediation server 600.

### Sixth Embodiment

This sixth embodiment is the same as the fourth embodiment other than the fact that the advertisement display module 400 in the fourth embodiment is managed by the third mediation server 600.

### Seventh Embodiment

This embodiment is characterized in that the function performed by the search target text generation module 300 in the first embodiment is performed by the advertisement search server 500. In this embodiment, the CS moving picture player 100 acquires text information from a moving picture and transmits the acquired text information to the advertisement search server 500. The search target text generation module 300 of the advertisement search server 500 generates search target text by processing the acquired text information, generates search results, including advertising content, based on the search target text, and transmits the advertising content of advertisers to the CS moving picture player 100 as the search results, including advertising content. Thereafter, the CS moving picture player 100 displays the received advertising content to users.

### Eighth Embodiment

The present embodiment integrates the characteristic of the seventh embodiment with the characteristic of the second embodiment, and the present embodiment is characterized in that the function performed by the search target text generation module 300 is performed by the advertisement search server 500, and the advertisement display module 400 is managed by the advertisement search server 500. Here, the CS moving picture player 100 performs functions of acquiring text information from a moving picture, and transmitting the acquired text information to the advertisement search server 500.

### Ninth Embodiment

This ninth embodiment has the same configuration and the same operational method as in the first embodiment, other than the facts that a function of collecting text information from a moving picture in the first embodiment is performed by the text information acquisition module 200 provided from a third ASP business, instead of by the manager of the CS moving picture player 100.

### Tenth Embodiment

This tenth embodiment has the same configuration and the same operational method as in the second embodiment other than the fact that a function of collecting text information from a moving picture in the second embodiment is performed by the text information acquisition module 200 provided from a third ASP business, instead of by the manager of the CS moving picture player 100.

### Eleventh Embodiment

This eleventh embodiment has the same configuration and the same operational method as in the third embodiment other than the fact that a function of collecting text information from a moving picture in the third embodiment is performed by the text information acquisition module 200 provided from a third ASP business, instead of by the manager of the CS moving picture player 100.

### Twelfth Embodiment

This twelfth embodiment has the same configuration and the same operational method as in the fourth embodiment other than the fact that a function of collecting text information from a moving picture in the fourth embodiment is performed by the text information acquisition module 200 provided from a third ASP business, instead of by the manager of the CS moving picture player 100.

### Thirteenth Embodiment

This thirteenth embodiment has the same configuration and the same operational method as in the fifth embodiment other than the fact that a function of collecting text information from a moving picture in the fifth embodiment is performed by the text information acquisition module 200 provided from a third ASP business, instead of by the manager of the CS moving picture player 100.

### Fourteenth Embodiment

This fourteenth embodiment has the same configuration and the same operational method as in the sixth embodiment other than the fact that a function of collecting text information from a moving picture in the sixth embodiment is performed by the text information acquisition module 200 provided from a third ASP business, instead of by the manager of the CS moving picture player 100.

### Fifteenth Embodiment

This fifteenth embodiment has the same configuration and the same operational method as in the seventh embodiment other than the fact that a function of collecting text information from a moving picture in the seventh embodiment is performed by the text information acquisition module 200 provided from a third ASP business, instead of by the manager of the CS moving picture player 100.

### Sixteenth Embodiment

This sixteenth embodiment has the same configuration and the same operational method as in the eighth embodiment other than the fact that a function of collecting text information from a moving picture in the eighth embodiment is performed by the text information acquisition module 200 provided from a third ASP business, instead of by the manager of the CS moving picture player 100.

### Seventeenth Embodiment

This seventeenth embodiment has the same configuration and the same operational method as in the first embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the first embodiment.

### Eighteenth Embodiment

This eighteenth embodiment has the same configuration and the same operational method as in the second embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the second embodiment.

### Nineteenth Embodiment

This nineteenth embodiment has the same configuration and the same operational method as in the third embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the third embodiment.

### Twentieth Embodiment

This twentieth embodiment has the same configuration and the same operational method as in the fourth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the fourth embodiment.

### Twenty-First Embodiment

This twenty-first embodiment has the same configuration and the same operational method as in the fifth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the fifth embodiment.

### Twenty-Second Embodiment

This twenty-second embodiment has the same configuration and the same operational method as in the sixth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the sixth embodiment.

### Twenty-Third Embodiment

This twenty-third embodiment has the same configuration and the same operational method as in the seventh embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the seventh embodiment.

### Twenty-Fourth Embodiment

This twenty-fourth embodiment has the same configuration and the same operational method as in the eighth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the eighth embodiment.

### Twenty-Fifth Embodiment

This twenty-fifth embodiment has the same configuration and the same operational method as in the ninth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the ninth embodiment.

### Twenty-Sixth Embodiment

This twenty-sixth embodiment has the same configuration and the same operational method as in the tenth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the tenth embodiment.

### Twenty-Seventh Embodiment

This twenty-seventh embodiment has the same configuration and the same operational method as in the eleventh embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the eleventh embodiment.

### Twenty-Eighth Embodiment

This twenty-eighth embodiment has the same configuration and the same operational method as in the twelfth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the twelfth embodiment.

### Twenty-Ninth Embodiment

This twenty-ninth embodiment has the same configuration and the same operational method as in the thirteenth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the thirteenth embodiment.

### Thirtieth Embodiment

This thirtieth embodiment has the same configuration and the same operational method as in the fourteenth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the fourteenth embodiment.

### Thirty-First Embodiment

This thirty-first embodiment has the same configuration and the same operational method as in the fifteenth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the fifteenth embodiment.

### Thirty-Second Embodiment

This thirty-second embodiment has the same configuration and the same operational method as in the sixteenth embodiment other than the facts that the playback of a moving picture occurs in the Web moving picture player 100-1 (a player for enabling a user to view a moving picture by playing the moving picture on the Web and transmitting the play results to a user's browser) executed by being installed in a server existing on a network, instead of in the CS moving picture player 100 executed by being installed in the user computer 10 in the sixteenth embodiment.

Now, the interface in which the player and the advertising content are displayed will be described.

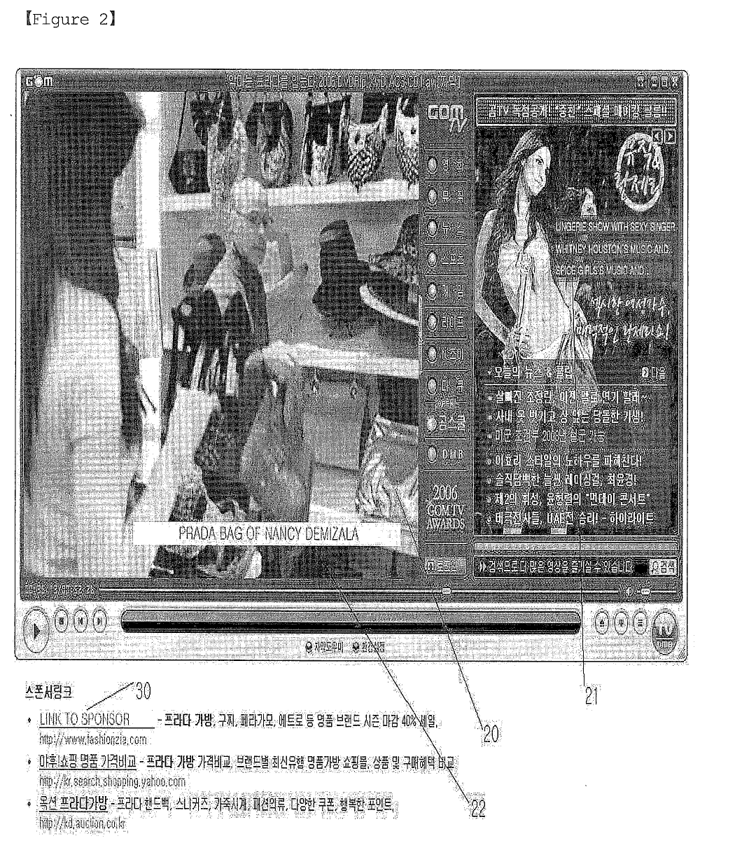

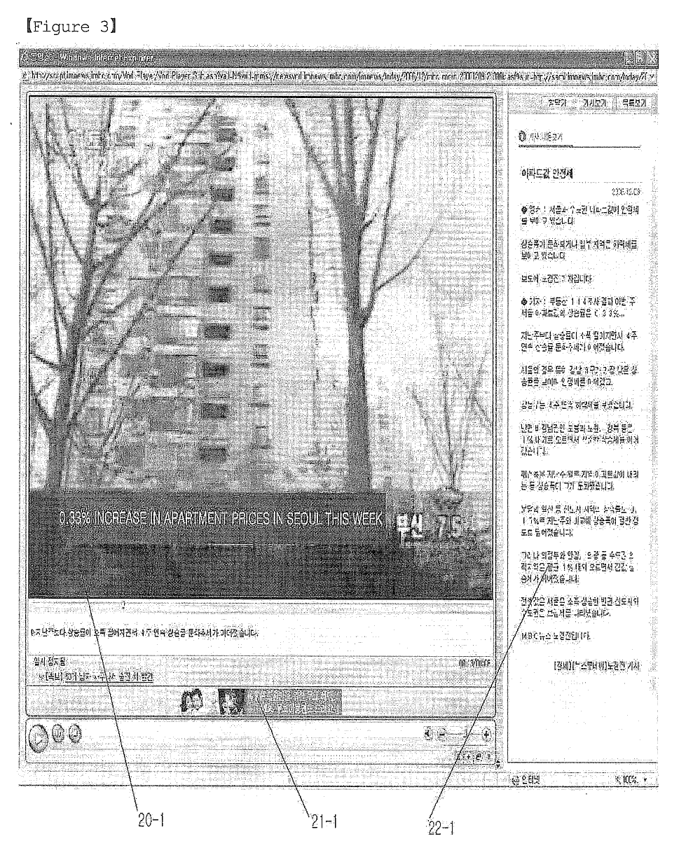

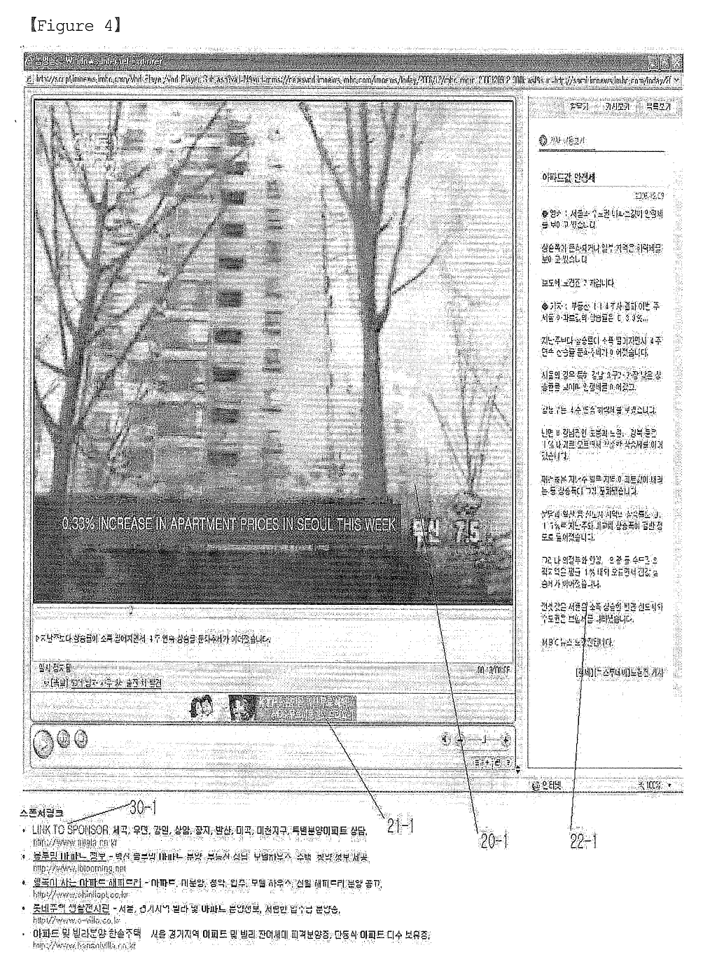

The interface according to the present invention is shown well in FIGS. 2 and 4. The interface for the CS moving picture player 100 according to the present invention is characterized in that it includes a moving picture play portion 20 and an advertisement display portion 30. Although it is preferable that the advertisement display portion 30 display search keyword advertisements, banner advertisements will make no difference as long as the content thereof is in conjunction with the content of the moving picture. Although it is preferable that the location of the advertisement display portion 30 be beneath the moving picture play portion 20, it will make no difference if the location of the advertisement display portion 30 is the right of the moving picture play portion 20 (in the case of ‘google.com’, the advertising content is displayed to the right of search results), or in the margin of the moving picture play portion 20, or within the frame recognized as the player. It is preferable that the size of the advertisement display portion 30 be adjusted in accordance with the size of the moving picture player, and, in particular, it is preferable that the size of the advertisement display portion 30 be no larger than the width of the screen of the moving picture player. In particular, in the case in which it is difficult for the advertisement display portion 30 to display all advertising content, any one of 1) a method of displaying only advertising content that can be included in a space in which the advertisement display portion 30 can perform display and 2) a method of displaying only advertisement keywords included in the advertising content may be adopted. The advertisement keyword may be “Prada bag” from the point of view in FIG. 2. Furthermore, the viewing of a moving picture player must not be disturbed by the advertisement display portion 30. That is, when the moving picture is displayed in a full screen, it is further preferable that the advertisement display portion 30 not be displayed.

The interface for the Web moving picture player 100-1 according to the present invention is characterized in that it includes a Web moving picture play portion 20-1 and a Web advertisement display portion 30-1. Although it is preferable that the Web advertisement display portion 30-1 display search keyword advertisement, banner advertisements will make no difference as long as the content thereof is in conjunction with the content of the moving picture. Although it is preferable that the location of the Web advertisement display portion 30-1 be beneath the Web moving picture play portion 20-1, it will make no difference if the location of the Web advertisement display portion 30 is the right of the Web moving picture play unit 20-1 or in the margin of the Web moving picture play unit 20-1. It is preferable that the size of the Web advertisement display portion 30-1 be no larger than the width of the screen of the moving picture player. In particular, in the case in which it is difficult for the Web advertisement display portion 30-1 to display all advertising content, any one of 1) a method of displaying only advertising content that can be included in a space in which the Web advertisement display portion 30-1 can perform display and 2) a method of displaying only advertisement keywords included in the advertising content may be adopted. The advertisement keyword may be “Prada bag” from the point of view in FIG. 2. Furthermore, the viewing of a moving picture player must not be disturbed by the Web advertisement display portion 30-1. That is, when the moving picture is displayed in a full screen, it is further preferable that the Web advertisement display portion 30-1 not be displayed.

1. A method of providing advertising content customized for content of a moving picture using text information acquired from the moving picture, the method comprising: acquiring text information from a moving picture that can be played by a player; transmitting at least one piece of search target text, included in the acquired text information, to at least one search server capable of providing search results for the search target text; receiving the search results from the search server; and displaying the received search results while the moving picture is being played.

2. The method according to claim 1, wherein the moving picture further comprises tag information, and the acquiring the text information comprises extracting the text information from information included in tags related to the moving picture.

3. The method according to claim 1, wherein the moving picture further comprises UCC (User Created Content) text for the moving picture, and the acquiring the text information comprises extracting the text information from UCC text for the moving picture, which is included in the moving picture.

4. The method according to claim 1, wherein the moving picture further comprises caption information, and the acquiring the text information comprises extracting the text information from the caption information.

5. (canceled)

6. The method according to claim 1, wherein the moving picture further comprises voice information, and the acquiring the text information comprises extracting the text information from voice recognition results in text form acquired from the voice information using a voice recognition program.

7. The method according to claim 1, further comprising processing the acquired text information;
wherein the processing the acquired text information comprises extracting at least one noun from the acquired text information.

8. The method according to claim 7, wherein the noun is at least one of a name of a product, a name of a service, and a proper noun.

9. The method according to claim 4, wherein the acquiring the text information is performed in synchronization with playback of the moving picture at predetermined time intervals while the moving picture is being played.

10. The method according to claim 9, wherein the moving picture is played using a streaming method or is played by being downloaded to a user computer.

11. The method according to claim 4, wherein the acquiring the text information comprises acquiring the text information for an entire moving picture at one time while storing time information in synchronization with the text information, which is being acquired, at predetermined time intervals.

12. The method according to claim 1, further comprising processing the acquired text information, wherein the processing the acquired text information comprises performing morpheme analysis on the acquired text information, and extracting at least one of a noun and a verb as a result of the morpheme analysis.

13. The method according to claim 1, wherein the search server generates search results including at least one piece of advertising content corresponding to a keyword using entire search target text, received by the search server, or text, including at least one word selected from the search target text, as the keyword.

14. (canceled)

15. (canceled)

16. The method according to claim 1, wherein the transmitting the search target text to the search server is performed at predetermined time intervals.

17. The method according to claim 1, wherein the search server generates at least one piece of advertising content of an advertiser, which corresponds to search target text, as the search results using a piece of search target text, received by the search server, as a keyword.

18-21. (canceled)

22. The method according to claim 1, wherein the search server transmits the search target text to a third server including a search index which enables the search results to be generated, and transmits the search results for the search target text, received from the third server, again.

23. The method according to claim 1, wherein the respective steps of claim 1 are generated from the player or software including the player.

24. The method according to claim 23, wherein the player is executed by being installed in a user computer.

25. The method according to claim 23, wherein the player is executed in a browser by being temporarily downloaded to the user computer.

26. The method according to claim 1, wherein the respective steps of claim 1 are generated from a predetermined server for providing the moving picture.

27. The method according to claim 4, wherein the acquiring the text information comprises acquiring the text information in synchronization with playback of the moving picture at predetermined time intervals while the moving picture is being played; and wherein the displaying the received search results while the moving picture is being played comprises displaying the received search results, which are different from each other, at the predetermined time intervals.

28. The method according to claim 1, wherein the search server is a server for providing a search portal service; and the search server generates search results including at least one piece of non-advertising content corresponding to a keyword using text, including at least one word, selected from the search target text received by the search server, as the keyword.

29-36. (canceled)

37. A system for providing advertising content customized for content of a moving picture using text information acquired from the moving picture, the system comprising: a moving picture player for playing a moving picture; a text information acquisition module for acquiring text information from the moving picture; a search target text generation module for generating at least one piece of search target text included in the text information acquired by the text information acquisition module; a module for communication with the search server for transmitting the search target text, generated by the search target text generation module, to at least one search server capable of transmitting search results for the search target text, and receiving the search results from the search server; and an advertisement display module for, before and after the moving picture, which is being played, is transmitted to a user computer or while the moving picture to the user computer, displaying the received search results including advertising content to a user in synchronization with the moving picture, which is being received.

38. The system according to claim 37, wherein the moving picture further comprises tag information; and the text information acquisition module acquiring the text information comprises extracting information included in tags related to the moving picture.

39. The system according to claim 37, wherein the moving picture further comprises UCC text for the moving picture, and the text information acquisition module acquiring the text information comprises extracting the text information from UCC text for the moving picture, which is included in the moving picture.

40. The system according to claim 37, wherein the moving picture further comprises caption information, and the text information acquisition module acquiring the text information comprises extracting the text information from the caption information.

41-58. (canceled)

59. The system according to claim 40, wherein the text information acquisition module acquiring the text information comprises acquiring the text information in synchronization with playback of the moving picture at predetermined time intervals while the moving picture is being played; and wherein the advertisement display module displaying the received search results while the advertisement display module plays moving picture comprises displaying the received search results, which are different from each other, at the predetermined time intervals.

60-66. (canceled)
